(19) United States
(12) Patent Application Publication
(10) Pub. No.: US 2023/0288826 A1
(43) Pub. Date: Sep. 14, 2023

(54) PROCESS CARTRIDGE AND ELECTROPHOTOGRAPHIC APPARATUS

(71) Applicant: CANON KABUSHIKI KAISHA, Tokyo (JP)

(72) Inventors: CHIHARU NAKAZONO, Shizuoka (JP); KANAME WATARIGUCHI, Kanagawa (JP); HIDEHARU SHIMOZAWA, Tokyo (JP); TSUTOMU NISHIDA, Shizuoka (JP); ATSUSHI OKUDA, Kanagawa (JP); TAIJI KATSURA, Shizuoka (JP); YUICHI KIKUCHI, Shizuoka (JP)

(21) Appl. No.: 18/178,731

(22) Filed: Mar. 6, 2023

(30) Foreign Application Priority Data
Mar. 14, 2022 (JP) 2022-039630

(51) Int. Cl. G03G 5/147; G03G 9/097; G03G 21/18

(52) U.S. Cl. CPC G03G 5/14734; G03G 9/09708; G03G 21/1814

(57) ABSTRACT

Provided is a process cartridge removably mountable onto a main body of an electrophotographic apparatus, the process cartridge comprising an electrophotographic photosensitive member, a toner, and a developing member configured to supply the toner to the electrophotographic photosensitive member, wherein, in filter fitting analysis in STEM-EDS analysis, a hydrotalcite particle comprises fluorine, and wherein, when a number-average primary particle diameter of a particle A is represented by “m” [nm], a content ratio of the particle A with respect to the surface layer is represented by “p” [vol %], and a number-average primary particle diameter of the hydrotalcite particle is represented by “h” [nm], the “m”, the “p”, and the “h” satisfy the following expressions, respectively:

5≤m≤300 Expression (1);

5≤p≤40 Expression (2); and

60≤h≤1,000 Expression (3).

### BACKGROUND OF THE INVENTION

### Field of the Invention

The present disclosure relates to a process cartridge and an electrophotographic apparatus each including an electrophotographic photosensitive member.

### Description of the Related Art

An electrophotographic apparatus in recent years has been enhanced in terms of increase in lifetime. In this connection, there has been a demand for an improvement in mechanical durability (wear resistance) of an electrophotographic photosensitive member. Meanwhile, discharge energy in a charging process in the electrophotographic apparatus sometimes generates various discharge products, such as NOx, SOx, and ozone, etc. When those discharge products themselves and atmospheric moisture adsorbed onto the discharge products are present on the electrophotographic photosensitive member, tackiness of a surface of the electrophotographic photosensitive member is increased. The increase in tackiness of the surface of the electrophotographic photosensitive member causes stick-slip between the electrophotographic photosensitive member and a contact member, thereby causing an adverse effect of images in some cases.

In Japanese Patent Application Laid-Open No. H09-034156, there is a description of an image forming apparatus including an electrophotographic photosensitive member with a protective layer containing electroconductive particles, fluorine atom-containing resin particles, and a binder resin. By virtue of the incorporation of the electroconductive particles and the fluorine atom-containing resin particles, releasability of the electrophotographic photosensitive member can be improved to suppress image unevenness called a “void”, which is caused by transfer deviation, and in which a center of a line or a letter is not transferred in a transferred image.

In Japanese Patent Application Laid-Open No. H02-166461, there is a description of a toner having a hydrotalcite compound incorporated thereinto. When hydrotalcite is constantly supplied to the surface of the electrophotographic photosensitive member throughout an electrophotographic process, the discharge products can be removed from the surface of the electrophotographic photosensitive member through utilization of ion exchangeability of the hydrotalcite. Thus, the increase in tackiness of the surface of the electrophotographic photosensitive member can be suppressed.

According to investigations made by the inventors, the technologies described in Japanese Patent Application Laid-Open No. H09-034156 and Japanese Patent Application Laid-Open No. H02-166461 have had a problem in that, particularly under high temperature and high humidity, minute stick-slip occurs between the electrophotographic photosensitive member and the contact member at the time of abutting rotation of the electrophotographic photosensitive member and the contact member to manifest as a horizontal streak-like uneven image. The horizontal streak-like uneven image is hereinafter referred to as “banding image”.

An object of the present disclosure is to provide a process cartridge capable of suppressing the occurrence of a banding image due to stick-slip between an electrophotographic photosensitive member and a contact member, thereby being capable of forming a high-quality electrophotographic image, even in repeated use over a long period of time under high temperature and high humidity.

### SUMMARY OF THE INVENTION

The above-mentioned object is achieved by the present disclosure described below. That is, a process cartridge according to the present disclosure is a process cartridge removably mountable onto a main body of an electrophotographic apparatus, the process cartridge comprising: an electrophotographic photosensitive member; a toner; and a developing member configured to supply the toner to the electrophotographic photosensitive member, wherein the electrophotographic photosensitive member comprises a surface layer comprising: a particle A containing a metal atom; and a binder resin, wherein the toner includes a hydrotalcite particle as an external additive, wherein, in filter fitting analysis in STEM-EDS analysis, the hydrotalcite particle comprises fluorine, and wherein, when a number-average primary particle diameter of the particle A is represented by “m” [nm], a content ratio of the particle A with respect to the surface layer is represented by “p” [vol %], and a number-average primary particle diameter of the hydrotalcite particle is represented by “h” [nm], the “m”, the “p”, and the “h” satisfy the following expressions (1), (2), and (3), respectively:

5≤m≤300 Expression (1);

5≤p≤40 Expression (2); and

60≤h≤1,000 Expression (3).

Further features of the present disclosure will become apparent from the following description of exemplary embodiments with reference to the attached drawings.

### BRIEF DESCRIPTION OF THE DRAWINGS

FIG. 1 is a schematic view for illustrating an example of an electrophotographic apparatus including a process cartridge with an electrophotographic photosensitive member, a toner, and a developing member.

FIG. 2 is an illustration of a contact model between the surface of the electrophotographic photosensitive member and a hydrotalcite particle.

FIG. 3 is an illustration of a cubic crystal model for investigating a relationship among “m”, “p”, and “h”.

FIG. 4A is a schematic view of line analysis in STEM-EDS analysis.

FIG. 4B shows an example of the X-ray intensity of fluorine obtained by the line analysis in the case where the hydrotalcite particle contains fluorine inside.

FIG. 4C shows an example of the X-ray intensities of fluorine and aluminum obtained by the line analysis in the case where the hydrotalcite particle contains fluorine derived from a surface treatment agent.

### DESCRIPTION OF THE EMBODIMENTS

The present disclosure is described in detail below by way of exemplary embodiments.

The present disclosure relates to a process cartridge removably mountable onto a main body of an electrophotographic apparatus, the process cartridge comprising: an electrophotographic photosensitive member; a toner; and a developing member configured to supply the toner to the electrophotographic photosensitive member, wherein the electrophotographic photosensitive member comprises a surface layer comprising: a particle A containing a metal atom; and a binder resin, wherein the toner includes: a toner particle; and a hydrotalcite particle as an external additive, wherein, in filter fitting analysis in STEM-EDS analysis, the hydrotalcite particle comprises fluorine, and wherein, when a number-average primary particle diameter of the particle A is represented by “m” [nm], a content ratio of the particle A with respect to the surface layer is represented by “p” [vol %], and a number-average primary particle diameter of the hydrotalcite particle is represented by “h” [nm], the “m”, the “p”, and the “h” satisfy the following expressions (1), (2), and (3), respectively:

5≤m≤300 Expression (1);

5≤p≤40 Expression (2); and

60≤h≤1,000 Expression (3).

The present disclosure also relates to an electrophotographic apparatus including the above-mentioned process cartridge.

The inventors presume that the mechanism by which the above-mentioned effect is expressed in the process cartridge of the present disclosure is as described below.

When the surface layer contains the particle A containing a metal atom, the releasability of the surface of the electrophotographic photosensitive member is improved to reduce its tackiness.

Nevertheless, in order to suppress banding in repeated use over a long period of time under high temperature and high humidity, the following two points are required besides the above-mentioned improvement in releasability.

(1) Particularly under high temperature and high humidity, the hydrotalcite particle is liable to absorb atmospheric moisture, which increases the tackiness when they are adsorbed onto the surface of the electrophotographic photosensitive member. Accordingly, it is required that moisture absorption by the hydrotalcite particle is suppressed.

(2) The hydrotalcite particle adsorbs a discharge product through ion exchange action. At that time, the hydrotalcite particle themselves is positively charged, and as the discharge product is negatively charged more strongly, the hydrotalcite particle more easily adsorbs the discharge product. Accordingly, it is required that the chargeability of the discharge product is rendered negative.

For (1), the hydrotalcite particle contains a fluorine atom, and hence high hydrophobicity resulting from the fluorine atom suppresses the absorption of atmospheric moisture.

For (2), the particle A containing a metal atom is contained in the surface layer, and hence the reducing action of the particle A facilitates negative charging of the discharge product. Accordingly, the adsorption of the discharge product onto the positively charged hydrotalcite particle is facilitated.

In addition to the foregoing, when the number-average primary particle diameter of the particle A is represented by “m” [nm], the content ratio of the particle A with respect to the surface layer is represented by “p” [vol %], and the number-average primary particle diameter of the hydrotalcite particle is represented by “h” [nm], it is required that the “m”, the “p”, and the “h” satisfy the following expressions (1), (2), and (3), respectively:

5≤m≤300 Expression (1);

5≤p≤40 Expression (2); and

60≤h≤1,000 Expression (3).

When “m”, “p”, and “h” fall within the ranges of the above-mentioned expressions, the size, spacing, and presence amount of the particle A exposed on the surface layer of the electrophotographic photosensitive member fall within ranges appropriate for the particle diameter of the hydrotalcite particle to be supplied onto the surface layer. As a result, the hydrotalcite particle is brought into point contact with the particle A, and hence, while tackiness therebetween is reduced, the discharge product can be sufficiently reduced to be adsorbed between layers of the hydrotalcite particle.

The effect of the present disclosure can be achieved by the synergistic effect of the above-mentioned actions.

[Electrophotographic Photosensitive Member]

The electrophotographic photosensitive member according to the present disclosure has a feature of including a surface layer.

A method of producing the electrophotographic photosensitive member of the present disclosure is, for example, a method involving: preparing coating liquids for the respective layers to be described later; applying the liquids in order of a desired layer; and drying the liquids. In this case, a method of applying each of the coating liquids is, for example, dip coating, spray coating, inkjet coating, roll coating, die coating, blade coating, curtain coating, wire bar coating, or ring coating. Among those, dip coating is preferred from the viewpoints of efficiency and productivity.

The respective layers are described below.

<Support>

In the present disclosure, the electrophotographic photosensitive member includes a support. In the present disclosure, the support is preferably an electroconductive support having electroconductivity. In addition, examples of the shape of the support include a cylindrical shape, a belt shape, and a sheet shape. Among those, a cylindrical support is preferred. In addition, the surface of the support may be subjected to, for example, electrochemical treatment such as anodization, blast treatment, or cutting treatment.

A metal, a resin, glass, etc. is preferred as a material for the support.

Examples of the metal include aluminum, iron, nickel, copper, gold, and stainless steel, which is an alloy thereof. Among those, aluminum is preferred. That is, a preferred example of the support is a support made of aluminum.

In addition, electroconductivity may be imparted to the resin or the glass through treatment of, for example, mixing or coating the resin or the glass with an electroconductive material.

<Electroconductive Layer>

In the electrophotographic photosensitive member of the present disclosure, an electroconductive layer may be arranged on the support. The arrangement of the electroconductive layer can conceal flaws and irregularities in the surface of the support, and control the reflection of light on the surface of the support.

The electroconductive layer preferably contains electroconductive particles and a resin.

A material for the electroconductive particles is, for example, a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Among those, a metal oxide is preferably used as the electroconductive particles, and in particular, titanium oxide, tin oxide, and zinc oxide are more preferably used.

When the metal oxide is used as the electroconductive particles, the surface of the metal oxide may be treated with a silane coupling agent etc., or the metal oxide may be doped with an element, such as phosphorus or aluminum, or an oxide thereof. The doped elements and their oxides include phosphorus, aluminum, niobium, tantalum, etc.

In addition, the electroconductive particles may have a laminated configuration having a core particle and a coating layer coating the particle. Materials of the core particle include titanium oxide, barium sulfate, and zinc oxide. Materials of the coating layer include a metal oxide such as tin oxide.

In addition, when the metal oxide is used as the electroconductive particles, their volume-average particle diameter is preferably 1 to 500 nm, more preferably 3 to 400 nm.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain a concealing agent, such as a silicone oil, resin particles, or titanium oxide.

The average thickness of the electroconductive layer is preferably 1 to 50 μm, particularly preferably 3 to 40 μm.

The electroconductive layer may be formed by: preparing a coating liquid for an electroconductive layer containing the above-mentioned respective materials and a solvent; forming a coating film of the liquid; and drying the coating film. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent. Dispersion method for dispersing the electroconductive particles in the coating liquid for an electroconductive layer include methods using a paint shaker, a sand mill, a ball mill, and a liquid collision-type high-speed disperser.

<Undercoat Layer>

In the electrophotographic photosensitive member of the present disclosure, an undercoat layer may be arranged on the support or the electroconductive layer. The arrangement of the undercoat layer can improve an adhesive function between layers to impart a charge injection-inhibiting function.

The undercoat layer preferably contains a resin. In addition, the undercoat layer may be formed as a cured film by polymerizing a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having a polymerizable functional group include an isocyanate group, a blocked isocyanate group, a methylol group, an alkylated methylol group, an epoxy group, a metal alkoxide group, a hydroxyl group, an amino group, a carboxy group, a thiol group, a carboxylic acid anhydride group, and an aliphatic hydrocarbon group having a carbon-carbon double bond.

In addition, the undercoat layer may further contain an electron-transporting substance, a metal oxide, a metal, an electroconductive polymer, etc. for the purpose of improving electric characteristics. Among those, an electron-transporting substance and a metal oxide are preferably used.

Examples of the electron-transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron-transporting substance having a polymerizable functional group may be used as the electron-transporting substance and copolymerized with the above-mentioned monomer having a polymerizable functional group to form an undercoat layer as a cured film.

Examples of the metal oxide include indium tin oxide, tin oxide, indium oxide, titanium oxide, zinc oxide, aluminum oxide, and silicon dioxide. Examples of the metal include gold, silver, and aluminum.

In addition, the undercoat layer may further contain an additive.

The average thickness of the undercoat layer is preferably 0.1 to 50 μm, more preferably 0.2 to 40 particularly preferably 0.3 to 30 μm.

The undercoat layer may be formed by: preparing a coating liquid for an undercoat layer containing the above-mentioned respective materials and a solvent; forming a coating film of the liquid; and drying and/or curing the coating film. Examples of the solvent to be used for the coating liquid include an alcohol-based solvent, a ketone-based solvent, an ether-based solvent, an ester-based solvent, and an aromatic hydrocarbon-based solvent.

<Photosensitive Layer>

The photosensitive layer of the electrophotographic photosensitive member is mainly classified into (1) a laminate-type photosensitive layer and (2) a monolayer-type photosensitive layer. (1) The laminate-type photosensitive layer has a charge-generating layer containing a charge-generating substance and a charge-transporting layer containing a charge-transporting substance. (2) The monolayer-type photosensitive layer has a photosensitive layer containing both a charge-generating substance and a charge-transporting substance.

(1) Laminate-type Photosensitive Layer

The laminate-type photosensitive layer has the charge-generating layer and the charge-transporting layer.

(1-1) Charge-Generating Layer

The charge-generating layer preferably contains the charge-generating substance and a resin.

Examples of the charge-generating substance include azo pigments, perylene pigments, polycyclic quinone pigments, indigo pigments, and phthalocyanine pigments. Among those, azo pigments and phthalocyanine pigments are preferred. Among the phthalocyanine pigments, an oxytitanium phthalocyanine pigment, a chlorogallium phthalocyanine pigment, and a hydroxygallium phthalocyanine pigment are preferred.

The content of the charge-generating substance in the charge-generating layer is preferably 40 to 85 mass %, more preferably 60 to 80 mass % with respect to the total mass of the charge-generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Among those, a polyvinyl butyral resin is more preferred.

In addition, the charge-generating layer may further contain an additive, such as an antioxidant or a UV absorber. Specific examples thereof include a hindered phenol compound, a hindered amine compound, a sulfur compound, a phosphorus compound, and a benzophenone compound.

The average thickness of the charge-generating layer is preferably 0.1 to 1 μm, more preferably 0.15 to 0.4 μm.

The charge-generating layer may be formed by: preparing a coating liquid for a charge-generating layer containing the above-mentioned respective materials and a solvent; forming a coating film of the liquid; and drying the coating film. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent.

(1-2) Charge-Transporting Layer

The charge-transporting layer preferably contains the charge-transporting substance and a resin.

Examples of the charge-transporting substance include a polycyclic aromatic compound, a heterocyclic compound, a hydrazone compound, a styryl compound, an enamine compound, a benzidine compound, a triarylamine compound, and a resin having a group derived from each of those substances. Among those, a triarylamine compound and a benzidine compound are preferred.

The content of the charge-transporting substance in the charge-transporting layer is preferably 25 to 70 mass %, more preferably 30 to 50 mass % with respect to the total mass of the charge-transporting layer.

Examples of the resin include a polyester resin, a polycarbonate resin, an acrylic resin, and a polystyrene resin. Among those, a polycarbonate resin and a polyester resin are preferred. A polyarylate resin is particularly preferred as the polyester resin.

A content ratio (mass ratio) between the charge-transporting substance and the resin is preferably from 4:10 to 20:10, more preferably from 5:10 to 12:10.

In addition, the charge-transporting layer may contain an additive, such as an antioxidant, a UV absorber, a plasticizer, a leveling agent, a slipperiness-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluororesin particles, polystyrene resin particles, polyethylene resin particles, silica particles, alumina particles, and boron nitride particles.

The average thickness of the charge-transporting layer is preferably 5 to 50 μm, more preferably 8 to 40 μm, particularly preferably 10 to 30 μm.

The charge-transporting layer may be formed by: preparing a coating liquid for a charge-transporting layer containing the above-mentioned respective materials and a solvent; forming a coating film of the liquid; and drying the coating film. Examples of the solvent to be used for the coating liquid include an alcohol-based solvent, a ketone-based solvent, an ether-based solvent, an ester-based solvent, and an aromatic hydrocarbon-based solvent. Among those solvents, an ether-based solvent or an aromatic hydrocarbon-based solvent is preferred.

(2) Monolayer-Type Photosensitive Layer

The monolayer-type photosensitive layer may be formed by: preparing a coating liquid for a photosensitive layer containing the charge-generating substance, the charge-transporting substance, a resin, and a solvent; forming a coating film of the liquid; and drying the coating film. Examples of the charge-generating substance, the charge-transporting substance, and the resin are the same as those of the materials in the section “(1) Laminate-type Photosensitive Layer.”

<Protective Layer>

In the electrophotographic photosensitive member of the present disclosure, a protective layer may be arranged on the photosensitive layer. The arrangement of the protective layer can improve durability.

It is appropriate that the protective layer is, for example, a resin-containing layer having high strength from the viewpoint that the layer is arranged for the purpose of imparting durability in response to long life. It is not necessarily required to enhance the charge-transporting performance by incorporating electroconductive particles or a charge-transporting substance into the layer. However, from the viewpoint of enhancing the basic electrical characteristics of the electrophotographic photosensitive member, it is preferred to achieve both the durability and the basic electrical characteristics by incorporating the electroconductive particles and/or the charge-transporting substance, and a resin.

Examples of the electroconductive particles include particles of metal oxides, such as titanium oxide, zinc oxide, tin oxide, and indium oxide.

Examples of the charge-transporting substance include a polycyclic aromatic compound, a heterocyclic compound, a hydrazone compound, a styryl compound, an enamine compound, a benzidine compound, a triarylamine compound, and a resin having a group derived from each of those substances. Among those, a triarylamine compound and a benzidine compound are preferred.

Examples of the resin include a polyester resin, an acrylic resin, a phenoxy resin, a polycarbonate resin, a polystyrene resin, a phenol resin, a melamine resin, and an epoxy resin. Among those, a polycarbonate resin, a polyester resin, and an acrylic resin are preferred.

In addition, the protective layer may be formed as a cured film by polymerizing a composition containing a monomer having a polymerizable functional group. Examples of reaction in this case include, for example, a thermal polymerization reaction, a photopolymerization reaction, and a radiation polymerization reaction. Examples of the polymerizable functional group of the monomer having a polymerizable functional group include an acryloyl group and a methacryloyl group. A material having a charge-transporting ability may be used as the monomer having a polymerizable functional group.

The protective layer may contain an additive, such as an antioxidant, a UV absorber, a plasticizer, a leveling agent, a slipperiness-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluororesin particles, polystyrene resin particles, polyethylene resin particles, silica particles, alumina particles, and boron nitride particles.

The average thickness of the protective layer is preferably 0.5 to 10 μm, more preferably 1 to 7 μm.

The protective layer may be formed by: preparing a coating liquid for a protective layer containing the above-mentioned respective materials and a solvent; forming a coating film of the liquid; and drying and/or curing the coating film. Examples of the solvent to be used for the coating liquid include an alcohol-based solvent, a ketone-based solvent, an ether-based solvent, a sulfoxide-based solvent, an ester-based solvent, and an aromatic hydrocarbon-based solvent.

<Surface Layer>

In the electrophotographic photosensitive member of the present disclosure, it is required that the surface layer contain the particle A containing a metal atom and the binder resin, and be formed with the number-average primary particle diameter “m” of the particle A being 5 to 300 nm, and the content ratio “p” of the particle A with respect to the surface layer being 5 to 40 vol %.

The surface layer as used herein is a portion in which the electrophotographic photosensitive member is brought into contact with a toner or various members in the electrophotographic process. The protective layer, the charge-transporting layer, the monolayer-type photosensitive layer, and the charge-generating layer may each serve as the surface layer. However, from the viewpoint of achieving both the durability and the basic electrical characteristics in the electrophotographic process, the surface layer is preferably the protective layer or the charge-transporting layer, more preferably the protective layer.

Examples of the particle A to be incorporated into the surface layer include elemental a metal particle, a metal oxide particle, a metal nitride particle, and a metal salt particle. Among those, a particle containing a metal oxide that allows easy control of resistance are preferred. Examples of the metal oxide include a metal oxide particle comprising a transition metal, such as magnesium oxide, zinc oxide, lead oxide, aluminum oxide, tantalum oxide, indium oxide, bismuth oxide, yttrium oxide, cobalt oxide, copper oxide, manganese oxide, selenium oxide, iron oxide, zirconium oxide, germanium oxide, tin oxide, titanium oxide, niobium oxide, molybdenum oxide, vanadium oxide, or silica. Among those, a titanium oxide particle and a tin oxide particle are preferred.

A polymer having high hardness, such as polycarbonate or polyarylate, may be used as the binder resin to be incorporated into the surface layer, but a resin obtained by polymerizing a crosslinkable polymerizable compound is more preferably incorporated because the wear resistance of the surface layer is improved.

The crosslinkable polymerizable compound is suitably a monomer that polymerizes (cures) when irradiated with an active ray, such as UV light or an electron beam, to become a resin to be generally used as a binder resin for an electrophotographic photosensitive member, such as polystyrene or polyacrylate. The crosslinkable polymerizable compound is particularly preferably a styrene-based monomer, an acrylic monomer, a methacrylic monomer, a vinyltoluene-based monomer, a vinyl acetate-based monomer, or an N-vinylpyrrolidone-based monomer. Among those, a radically polymerizable compound having an acryloyl group (CH₂═CHCO—) or a methacryloyl group (CH₂═CCH₃CO—) is particularly preferred because the compound can easily polymerize with heat or light and form a surface layer having high wear resistance.

The particle A is preferably subjected to surface treatment, and for example, it is conceivable to subject the particle A to surface treatment with a hole-transportable compound in order to improve a charge-transporting function, or to subject the particle A to silane coupling treatment in order for the particle A in the surface layer to be prevented from being aggregated and be uniformly dispersed. Among those, silane coupling treatment is preferably performed in light of the effect of the present disclosure.

In addition, the surface treatment of the particle A may be treatment with a compound having a polymerizable monomer, and for example, it is preferred that a (meth)acryloyloxy group is bonded to the surface of the particle A. When the particle A has a (meth)acryloyloxy group, in the case where the resin of the surface layer is an acrylic resin, the particle A is improved in affinity for a chain-polymerizable functional group, and hence can be prevented from being eliminated from the surface layer even in long-term use.

[Toner]

The toner of the present disclosure has a feature of including a toner particle and an external additive.

Each component for forming the toner and a method of producing the toner are described below.

<Method of Producing Toner>

A method of producing a toner particle is described.

A known method may be used as the method of producing a toner particle, and a kneading and pulverization method or a wet production method may be used. From the viewpoints of uniformization of particle diameters and shape controllability, the wet production method may be preferably used. Further, examples of the wet production method include a suspension polymerization method, a dissolution suspension method, an emulsion polymerization aggregation method, and an emulsion aggregation method, and the emulsion aggregation method may be preferably used.

In the emulsion aggregation method, materials, such as fine particles of a binder resin and fine particles of a colorant, are first dispersed and mixed in an aqueous medium containing a dispersion stabilizer. A surfactant may be added to the aqueous medium. After that, aggregation is performed by adding an aggregating agent until desired particle diameters of the toner particle is obtained, and after or at the same time as the aggregation, the resin fine particles are fused together. Further, as required, thermal shape control is performed to form a toner particle.

Here, the fine particle of the binder resin may be composite a particle formed of a plurality of layers having a configuration of two or more layers of resins with different compositions. For example, the fine particle may be produced by an emulsion polymerization method, a mini-emulsion polymerization method, a phase-transfer emulsification method, etc., or may be produced by a combination of several production methods.

When an internal additive such as a colorant is incorporated into the toner particle, the internal additive may be incorporated into a resin fine particle. Alternatively, a dispersion liquid of an internal additive fine particle formed of only the internal additive may be prepared, and the internal additive fine particles may be aggregated together when the resin fine particles are aggregated.

In addition, toner particle having a configuration of layers with different compositions may be prepared by adding resin fine particles with different compositions with a time difference during aggregation, followed by aggregation.

The following dispersion stabilizers may each be used as the dispersion stabilizer.

As an inorganic dispersion stabilizer, there are given tricalcium phosphate, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica, and alumina.

In addition, an organic dispersion stabilizer includes polyvinyl alcohol, gelatin, methylcellulose, methylhydroxypropylcellulose, ethylcellulose, carboxymethylcellulose sodium salt, and starch.

A known cationic surfactant, anionic surfactant, or nonionic surfactant may be used as the surfactant.

Specific examples of the cationic surfactant include dodecylammonium bromide, dodecyltrimethylammonium bromide, dodecylpyridinium chloride, dodecylpyridinium bromide, and hexadecyltrimethylammonium bromide.

Specific examples of the nonionic surfactant include dodecyl polyoxyethylene ether, hexadecyl polyoxyethylene ether, nonylphenyl polyoxyethylene ether, lauryl polyoxyethylene ether, sorbitan monooleate polyoxyethylene ether, styrylphenyl polyoxyethylene ether, and monodecanoyl sucrose.

Specific examples of the anionic surfactant may include aliphatic soaps, such as sodium stearate and sodium laurate, sodium lauryl sulfate, sodium dodecylbenzene sulfonate, and sodium polyoxyethylene (2) lauryl ether sulfate.

<Binder Resin>

A binder resin for forming the toner particle is described.

Suitable examples of the binder resin may include a vinyl-based resin and a polyester resin.

Examples of the vinyl-based resin, the polyester resin, and the other binder resins may include the following resins or polymers:
homopolymers of styrene and substituted styrenes, such as polystyrene and polyvinyltoluene; styrene-based copolymers, such as a styrene-propylene copolymer, a styrene-vinyltoluene copolymer, a styrene-vinylnaphthalene copolymer, a styrene-methyl acrylate copolymer, a styrene-ethyl acrylate copolymer, a styrene-butyl acrylate copolymer, a styrene-octyl acrylate copolymer, a styrene-dimethylaminoethyl acrylate copolymer, a styrene-methyl methacrylate copolymer, a styrene-ethyl methacrylate copolymer, a styrene-butyl methacrylate copolymer, a styrene-dimethylaminoethyl methacrylate copolymer, a styrene-vinyl methyl ether copolymer, a styrene-vinyl ethyl ether copolymer, a styrene-vinyl methyl ketone copolymer, a styrene-butadiene copolymer, a styrene-isoprene copolymer, a styrene-maleic acid copolymer, and a styrene-maleate ester copolymer; and polymethyl methacrylate, polybutyl methacrylate, polyvinyl acetate, polyethylene, polypropylene, polyvinyl butyral, a silicone resin, a polyamide resin, an epoxy resin, a polyacrylic resin, a rosin, a modified rosin, a terpene resin, a phenol resin, an aliphatic or alicyclic hydrocarbon resin, and an aromatic petroleum resin. Those binder resins may be used alone or as a mixture thereof.

The binder resin preferably contains a carboxy group, and is preferably a resin produced by using a polymerizable monomer containing a carboxy group. Examples thereof include: vinylcarboxylic acids, such as acrylic acid, methacrylic acid, α-ethyl acrylic acid, and crotonic acid; unsaturated dicarboxylic acids, such as fumaric acid, maleic acid, citraconic acid, and itaconic acid; and unsaturated dicarboxylic acid monoester derivatives, such as monoacryloyloxyethyl succinate, monomethacryloyloxyethyl succinate, monoacryloyloxyethyl phthalate, and monomethacryloyloxyethyl phthalate.

Condensation polymerization products of the following carboxylic acid components and alcohol components may each be used as the polyester resin. Examples of the carboxylic acid component include terephthalic acid, isophthalic acid, phthalic acid, fumaric acid, maleic acid, cyclohexanedicarboxylic acid, and trimellitic acid. Examples of the alcohol component include bisphenol A, hydrogenated bisphenol, an ethylene oxide adduct of bisphenol A, a propylene oxide adduct of bisphenol A, glycerin, trimethylolpropane, and pentaerythritol.

In addition, the polyester resin may be a polyester resin containing a urea group. It is preferred that a carboxy group at, for example, a terminal of the polyester resin is not capped.

<Crosslinking Agent>

A crosslinking agent may be added in case of the polymerization of the polymerizable monomer for controlling the molecular weight of the binder resin for forming the toner particle.

Examples thereof include ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, neopentyl glycol diacrylate, divinylbenzene, bis(4-acryloxypolyethoxyphenyl)propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, diacrylates of polyethylene glycol #200, #400, and #600, dipropylene glycol diacrylate, polypropylene glycol diacrylate, and a polyester-type diacrylate (MANDA, Nippon Kayaku Co., Ltd.), and compounds obtained by changing those acrylates to methacrylates.

The addition amount of the crosslinking agent is preferably 0.001 to 15.000 parts by mass with respect to 100 parts by mass of the polymerizable monomer.

<Release Agent>

It is preferred that a release agent is incorporated as one of the materials for forming the toner particle. In particular, when an ester wax having a melting point of 60 to 90° C. is used, a plasticizing effect is easily obtained because of the excellent compatibility of the ester wax with the binder resin.

Examples of the ester wax include: waxes each including a fatty acid ester as a main component, such as a carnauba wax and a montanic acid ester wax; a wax obtained by removing part or the whole of an acid component from a fatty acid ester such as a deacidified carnauba wax; a methyl ester compound having a hydroxy group obtained by, for example, hydrogenating a plant oil and fat; saturated fatty acid monoesters, such as stearyl stearate and behenyl behenate; diesterified products of a saturated aliphatic dicarboxylic acid and a saturated aliphatic alcohol, such as dibehenyl sebacate, distearyl dodecanedioate, and distearyl octadecanedioate; and diesterified products of a saturated aliphatic diol and a saturated aliphatic monocarboxylic acid, such as nonanediol dibehenate and dodecanediol distearate.

Among those waxes, a bifunctional ester wax (diester) having two ester bonds in a molecular structure thereof is preferably included.

The bifunctional ester wax is an ester compound of a dihydric alcohol and an aliphatic monocarboxylic acid, or an ester compound of a divalent carboxylic acid and an aliphatic monoalcohol.

Specific examples of the aliphatic monocarboxylic acid include myristic acid, palmitic acid, stearic acid, arachidic acid, behenic acid, lignoceric acid, cerotic acid, montanic acid, melissic acid, oleic acid, vaccenic acid, linoleic acid, and linolenic acid.

Specific examples of the aliphatic monoalcohol include myristyl alcohol, cetanol, stearyl alcohol, arachidyl alcohol, behenyl alcohol, tetracosanol, hexacosanol, octacosanol, and triacontanol.

Specific examples of the divalent carboxylic acid include butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), dodecanedioic acid, tridecanedioic acid, tetradecanedioic acid, hexadecanedioic acid, octadecanedioic acid, eicosanedioic acid, phthalic acid, isophthalic acid, and terephthalic acid.

Specific examples of the dihydric alcohol include ethylene glycol, propylene glycol, 1,3-propanediol, 1,4-butanediol, 1,5-pentanediol, 1,6-hexanediol, 1,10-decanediol, 1,12-dodecanediol, 1,14-tetradecanediol, 1,16-hexadecanediol, 1,18-octadecanediol, 1,20-eicosanediol, 1,30-triacontanediol, diethylene glycol, dipropylene glycol, 2,2,4-trimethyl-1,3-pentanediol, neopentyl glycol, 1,4-cyclohexane dimethanol, spiroglycol, 1,4-phenylene glycol, bisphenol A, and hydrogenated bisphenol A.

Examples of the other release agent that may be used include: a petroleum-based wax, such as a paraffin wax, a microcrystalline wax, or petrolatum, and derivatives thereof; a montan wax and derivatives thereof; a hydrocarbon-based wax obtained by a Fischer-Tropsch method and derivatives thereof; a polyolefin wax, such as polyethylene or polypropylene, and derivatives thereof; a natural wax, such as a carnauba wax or a candelilla wax, and derivatives thereof; a higher aliphatic alcohol; and a fatty acid, such as stearic acid or palmitic acid, or compounds thereof.

The content of the release agent is preferably 5.0 to 20.0 parts by mass with respect to 100.0 parts by mass of the binder resin or the polymerizable monomer.

<Colorant>

When a colorant is incorporated into the toner particle, the colorant is not particularly limited, and known colorants described below may be used.

As yellow pigments, yellow iron oxide, naples yellow, condensed azo compounds, such as Naphthol Yellow S, Hansa Yellow G, Hansa Yellow 10G, Benzidine Yellow G, Benzidine Yellow GR, quinoline yellow lake, Permanent yellow NCG, and tartrazine lake; isoindolinone compounds, anthraquinone compounds, azo metal complexes, methine compounds, and allyl amide compounds are used. Specific examples thereof include the following pigments:
C.I. Pigment Yellow 12, 13, 14, 15, 17, 62, 74, 83, 93, 94, 95, 109, 110, 111, 128, 129, 147, 155, 168, and 180.

Examples of red pigments include colcothar, condensed azo compounds, such as Permanent Red 4R, lithol red, pyrazolone red, watching red calcium salt, lake red C, lake red D, Brilliant Carmine 6B, Brilliant Carmine 3B, eosin lake, rhodamine lake B, and alizarin lake; diketopyrrolopyrrole compounds, anthraquinone compounds, quinacridone compounds, basic dye lake compounds, naphthol compounds, benzimidazolone compounds, thioindigo compounds, and perylene compounds. Specific examples thereof include the following pigments:
C.I. Pigment Red 2, 3, 5, 6, 7, 23, 48:2, 48:3, 48:4, 57:1, 81:1, 122, 144, 146, 166, 169, 177, 184, 185, 202, 206, 220, 221, and 254.

Examples of blue pigments include alkali blue lake, Victoria blue lake, phthalocyanine blue, metal-free phthalocyanine blue, partially chlorinated phthalocyanine blue, fast sky blue, copper phthalocyanine compounds such as indanthrene blue BG, and derivatives thereof, anthraquinone compounds, and basic dye lake compounds. Specific examples thereof include the following pigments:
C.I. Pigment Blue 1, 7, 15, 15:1, 15:2, 15:3, 15:4, 60, 62, and 66.

Examples of black pigments include carbon black and aniline black. Those colorants may be used alone or as a mixture thereof, and even in a solid solution.

The content of the colorant is preferably 3.0 to 15.0 parts by mass or with respect to 100.0 parts by mass of the binder resin or the polymerizable monomer.

<Charge Control Agent and Charge Control Resin>

The toner particle may contain a charge control agent. A known charge control agent may be used as the charge control agent. In particular, a charge control agent having a high charging speed and being capable of stably maintaining a constant charge quantity is preferred.

Examples of the charge control agent that controls a toner particle so that the particle may be negatively chargeable include the following agents:
Examples of organometallic compounds and chelate compounds include a monoazo metal compound, an acetylacetone metal compound, and aromatic oxycarboxylic acid-, aromatic dicarboxylic acid-, oxycarboxylic acid-, and dicarboxylic acid-based metal compounds. Other examples thereof include aromatic oxycarboxylic acids, and aromatic mono- and polycarboxylic acids, and metal salts, anhydrides, or esters thereof, and phenol derivatives such as bisphenol. Further, examples thereof include a urea derivative, a salicylic acid-based compound containing a metal, a naphthoic acid-based compound containing a metal, a boron compound, a quaternary ammonium salt, and a calixarene.

Meanwhile, examples of the charge control agent that controls a toner particle so that the particle may be positively chargeable include the following agents: a modified nigrosine compound; a guanidine compound; an imidazole compound; quaternary ammonium salts, such as a tributylbenzylammonium-1-hydroxy-4-naphtosulfonate and tetrabutylammonium tetrafluoroborate, and onium salts that are analogs of the above-mentioned compounds such as a phosphonium salt, and lake pigments thereof; a triphenylmethane dye and a lake pigment thereof (examples of a laking agent include phosphotungstic acid, phosphomolybdic acid, phosphotungstic molybdic acid, tannic acid, lauric acid, gallic acid, a ferricyanide, and a ferrocyanide, etc.); a metal salt of a higher fatty acid; and a resin-based charge control agent.

The charge control agents may be incorporated alone or in combination of two or more kinds.

The content of the charge control agent is preferably 0.01 to 100.00 parts by mass with respect to 100.00 parts by mass of the binder resin or the polymerizable monomer.

<External Additive>

It is required that: the toner of the present disclosure include the hydrotalcite particle as an additive; the hydrotalcite particle contain fluorine in filter fitting analysis in STEM-EDS analysis; and the number-average primary particle diameter “h” of the hydrotalcite particle be 60 to 1,000 nm. When “h” is more than 1,000 nm, the flowability of the toner is likely to be reduced, and as a result, a reduction in chargeability in repeated use over a long period of time is likely to occur.

The hydrotalcite particle is generally represented by the following structural formula (1):

M²⁺_{y}M³⁺ₓ(OH)₂Aⁿ⁻_{(x/n)}·mH₂O Formula (1)
where 0≤x≤0.5, y=1−x, and m≥0.

The M²⁺ and the M³⁺ represent divalent and trivalent metals, respectively.

The M²⁺ preferably represents at least one divalent metal ion selected from the group consisting of: Mg; Zn; Ca; Ba; Ni; Sr; Cu; and Fe. The M³⁺ preferably represents at least one trivalent metal ion selected from the group consisting of: Al; B; Ga; Fe; Co; and In. Among those, the M²⁺ and the M³⁺ preferably represent Mg and Al, respectively.

The Aⁿ⁻ represents an n-valent anion, and examples thereof include CO₃²⁻, OH⁻, Cl⁻, I⁻, F⁻, Br⁻, SO₄²⁻, HCO₃⁻, CH₃COO⁻, and NO₃⁻. Those anions may be present alone or in a plurality of kinds thereof.

The hydrotalcite particle of the present disclosure have a feature of containing fluorine. There is no particular limitation on a method of incorporating fluorine into the hydrotalcite particle, and examples thereof include a method of treating the hydrotalcite particle with a coupling treatment agent containing fluorine and a method of treating the hydrotalcite particle in an aqueous solution containing a fluoride ion. A method of performing wet treatment in an aqueous solution containing a fluoride ion is preferred from the viewpoint of uniform treatment. In the present disclosure, it is preferred that magnesium is contained as the divalent metal ion M²⁺, and that aluminum is contained as the trivalent metal ion M³⁺. That is, the hydrotalcite particle of the present disclosure are preferably hydrotalcite particle comprising fluorine, magnesium, and aluminum.

The hydrotalcite particle may be a solid solution containing a plurality of different elements. In addition, the hydrotalcite particle may contain a trace amount of a monovalent metal.

In addition, the hydrotalcite particle preferably has water in the molecule thereof, and more preferably satisfy 0.1≤m≤0.6 in the formula (1).

The hydrotalcite particle may be subjected to hydrophobic treatment with a surface treatment agent separately from the fluorine treatment. Higher fatty acids, coupling agents, esters, and oils such as a silicone oil may each be used as the surface treatment agent. Among those, higher fatty acids are preferably used. Specific examples thereof include stearic acid, oleic acid, and lauric acid.

In the fluorine-containing hydrotalcite particle, it is preferred that fluorine is present inside of the hydrotalcite particle in the line analysis in the STEM-EDS analysis.

When fluorine is contained inside of the hydrotalcite particle, fluorine is supplied onto the electrophotographic photosensitive member in exchange for the adsorption of a discharge product by ion exchange. As a result, the appropriate supply of fluorine is easily performed in conjunction with the progress of the discharge to the electrophotographic photosensitive member by repeated use. Accordingly, the tackiness of the photosensitive drum can be easily reduced.

<Method of Identifying Hydrotalcite Particle>

The identification of the hydrotalcite particle as an external additive may be performed by combining shape observation with a scanning electron microscope (SEM) and elemental analysis by energy-dispersive X-ray spectroscopy (EDS).

A toner is observed in a field of view enlarged by up to 50,000 times with a scanning electron microscope “S-4800” (product name; manufactured by Hitachi, Ltd.). The surface of the toner particle is brought into focus, and the external additive to be discriminated is observed. The EDS analysis of the external additive to be discriminated is performed, thereby being capable of identifying the hydrotalcite particle from the kinds of element peaks.

When an element peak of at least one metal selected from the group consisting of: Mg; Zn; Ca; Ba; Ni; Sr; Cu; and Fe, which are metals that may form a hydrotalcite particle, and an element peak of at least one metal selected from the group consisting of: Al; B; Ga; Fe; Co; and In are observed as the element peaks, the presence of the hydrotalcite particle containing the above-mentioned two kinds of metals can be analogized.

A specimen of the hydrotalcite particle analogized by the EDS analysis is separately prepared, and the shape observation with the SEM and the EDS analysis are performed. The analysis results of the specimen are compared to those of the particles to be discriminated to recognize whether or not the analysis results of the specimen are matched with those of the particles to be discriminated, to thereby determine whether or not the particle is a hydrotalcite particle.

[Charging Roller]

The process cartridge according to the present disclosure may include a charging member. The charging member is preferably a charging roller having a universal hardness of from 1.0 N/mm² to 20.0 N/mm² or less at a position having a depth of 1 μm from the surface thereof, and the charging roller may include an electroconductive support and an electroconductive layer arranged on the outer peripheral surface of the electroconductive support.

In case of the abutment of the charging roller with the photosensitive drum (electrophotographic photosensitive member), when the universal hardness is 20 N/mm² or less, the charging roller abutting on the photosensitive drum can suitably deform to suppress the vibration of the photosensitive drum, to thereby suppress a banding image. It is more preferred that the universal hardness is 10.0 N/mm² or less.

When the universal hardness is more than 20.0 N/mm², the charging roller is not deformed by the abutment with the photosensitive drum, and hence the suppressing effect of the charging roller on the vibration of the photosensitive drum is reduced. Further, the vibration of the charging roller itself is increased, and hence the banding image becomes difficult to suppress in some cases.

The universal hardness of the surface of the charging roller is measured using, for example, a universal hardness meter (product name: FISCHERSCOPE HM2000XYp, manufactured by Fischer Instruments K.K.). The “universal hardness” is a physical property value determined by pushing an indenter into a measurement object while applying a load, and is determined as “(test load)/(surface area of indenter under test load) (N/mm²).” An indenter such as a quadrangular pyramid is pushed into the object to be measured while a predetermined relatively small test load is applied, and at the time point when a predetermined indentation depth is reached, a surface area with which the indenter is brought into contact is determined from the indentation depth, and the universal hardness is determined from the above-mentioned expression.

The universal hardness of the charging roller may be controlled based on the chemical structures of the resin components (rubber material and binder resin) of the electroconductive layer, and the kinds and addition amounts of a filler and a vulcanizing agent. In addition, the hardness of the surface of the charging roller may be controlled through surface treatment for the surface of the electroconductive layer. Further, in the case of a charging roller configuration in which an electroconductive surface layer is arranged, the universal hardness may be controlled based on the thickness of the surface layer, an additive, a dispersant, and etc.

Details about the charging roller according to the present disclosure are described below.

The charging roller preferably has a configuration including an electroconductive support and an electroconductive layer arranged on the outer peripheral surface of the electroconductive support. The electroconductive layer may be mainly formed of a resin material, a rubber material, etc., but is preferably an electroconductive elastic layer containing a rubber material in order to suitably perform abutment with the photosensitive drum.

A configuration in which one electroconductive layer is arranged on the outer peripheral surface of the electroconductive support, or a configuration in which two or more electroconductive layers are arranged on that may be appropriately selected for the electroconductive elastic layer to the extent that the effect of the present disclosure can be expressed.

<Electroconductive Support>

A material for forming the electroconductive support there can be selected from materials known in the field of electroconductive members for electrophotography, and materials that may be utilized as such electroconductive members. Examples thereof include aluminum, stainless steel, a synthetic resin having electroconductivity, iron, a copper alloy, and other metals or alloys. Further, any such material may be subjected to oxidation treatment or plating treatment with chromium, nickel, etc. Any of electroplating and electroless plating may be used as the kind of the plating. From the viewpoint of dimensional stability, electroless plating is preferred. Examples of the kind of the electroless plating to be used in this case may include nickel plating, copper plating, gold plating, and various other kinds of alloy plating. A plating thickness is preferably 0.05 μm or more, and in consideration of balance between working efficiency and rust-preventing ability, the plating thickness is preferably from 0.1 μm to 30 μm. The columnar shape of the support may be a solid columnar shape, or may be a hollow columnar shape (cylindrical shape). The outer diameter of the support preferably falls within the range of from φ3 mm to φ10 mm.

A material for forming the electroconductive elastic layer is preferably mainly formed of a rubber material in order to suitably perform abutment with the photosensitive drum. In addition, an electroconductive agent for imparting electroconductivity and any other filler may be added to the extent that the effect of the present disclosure is not impaired. As those materials, materials appropriately selected from ones known in the field of electroconductive members for electrophotography, and materials that may be utilized as such electroconductive members, such as listed below may be used.

<List of Rubber Materials>

Specific examples of the rubber material for forming the electroconductive elastic layer include: raw material rubbers, such as natural rubber (NR), an isoprene rubber (IR), a butadiene rubber (BR), a styrene-butadiene rubber (SBR), a butyl rubber (IIR), an ethylene-propylene-diene terpolymer rubber (EPDM), an epichlorohydrin homopolymer (CHC), an epichlorohydrin-ethylene oxide copolymer (CHR), an epichlorohydrin-ethylene oxide-allyl glycidyl ether terpolymer (CHR-AGE), an acrylonitrile-butadiene copolymer (NBR), a hydrogenated product of an acrylonitrile-butadiene copolymer (H-NBR), a chloroprene rubber (CR), and an acrylic rubber (ACM, ANM); and liquid rubbers, such as a liquid butadiene rubber and a liquid styrene butadiene rubber. Those rubbers may be used alone or in combination of two or more kinds.

<Electroconductive Material>

An electroconductive material, such as an ionic electroconductive agent or an electronic electroconductive agent, may be appropriately blended as an electroconductive material for imparting electroconductivity to the electroconductive elastic layer.

Examples of the ionic electroconductive agent include: inorganic ionic substances, such as lithium perchlorate, sodium perchlorate, and calcium perchlorate; cationic surfactants, such as lauryltrimethylammonium chloride, stearyltrimethylammonium chloride, octadecyltrimethylammonium chloride, dodecyltrimethylammonium chloride, hexadecyltrimethylammonium chloride, trioctylpropylammonium bromide, and a modified aliphatic dimethylethylammonium ethosulfate; amphoteric ion surfactants, such as lauryl betaine, stearyl betaine, and a dimethylalkyl lauryl betaine; quaternary ammonium salts, such as tetraethylammonium perchlorate, tetrabutylammonium perchlorate, and trim ethyloctadecylammonium perchlorate; and organic acid lithium salts such as lithium trifluoromethanesulfonate. Those ionic electroconductive agents may be used alone or in combination of two or more kinds.

Examples of the electronic electroconductive agent include: metal-based fine particles and fibers, such as aluminum, palladium, iron, copper, and silver; and metal oxides, such as titanium oxide, tin oxide, and zinc oxide, which are subjected to electroconductive treatment; composite particles obtained by subjecting the surfaces of the above-mentioned metal-based fine particles and fibers, and metal oxides to surface treatment through electrolytic treatment, spray coating, and mixing and shaking; and carbon powders, such as furnace black, thermal black, acetylene black, ketjen black, polyacrylonitrile (PAN)-based carbon, and pitch-based carbon. Examples of the furnace black include SAF-HS, SAF, ISAF-HS, ISAF, ISAF-LS, I-ISAF-HS, HAF-HS, HAF, HAF-LS, T-HS, T-NS, MAF, FEF, GPF, SRF-HS-HM, SRF-LM, ECF, and FEF-HS. Examples of the thermal black include FT and MT. Among those, carbon black is preferred because the carbon black is relatively easily available and provides satisfactory electroconductivity.

<Other Additives>

A filler, a processing aid, an age resistor, a crosslinking aid, a crosslinking accelerator, a crosslinking acceleration aid, a crosslinking retarder, a dispersant, a foaming agent, resin particles, inorganic particles, etc., each of which is generally used as a compounding agent for a rubber, may be added to the electroconductive elastic layer as required.

<Resin Particles>

Resin particles or inorganic particles may be added to the electroconductive elastic layer. In order to suitably perform abutment with the photosensitive drum and rotation, resin particles are preferred, and as a material for the resin particles, a resin known in the field of electroconductive members for electrophotography, for example, a resin such as a polyurethane resin, a polyester resin, a polyethylene resin, a polyether resin, a polyamide resin, an acrylic resin, or a phenol resin may be used.

<Production Method>

A method of producing the electroconductive elastic layer may be exemplified by a production method of: mixing the above-mentioned rubber material, electroconductive material, and other additives through use of a closed mixer, such as a Banbury mixer or a pressure kneader, or an open mixer such as an open roll, and then forming an unvulcanized electroconductive elastic layer on the outer peripheral surface of the electroconductive support by a method, such as extrusion molding, injection molding, or molding, followed by vulcanization and curing by a method such as heating, a grinding step, and surface treatment.

<Method of controlling Universal Hardness in Electroconductive Elastic Layer>

When the charging roller is formed of the electroconductive support and the electroconductive elastic layer formed on the outer peripheral surface of the electroconductive support, such a method as described below may be used as a method of controlling the universal hardness of the surface of the charging roller. An example of the method of controlling the universal hardness is a method of irradiating the surface of the charging roller with an energy ray, such as UV light, an electron beam, or heat, to promote the crosslinking of the resin material in the surface of the elastic layer, to thereby control the hardness of the outermost surface. Among those, a method of irradiation with UV light, which is capable of controlling the universal hardness to a low value, is preferably used.

<Electroconductive Surface Layer>

Further, as described below, an electroconductive surface layer may be further formed on the outer peripheral surface of the electroconductive elastic layer produced as described above.

When the charging roller has a two-layer configuration, materials for forming the electroconductive surface layer to be formed on further outer peripheral surface of the electroconductive elastic layer to be formed on the outer peripheral surface of the electroconductive support include a binder resin and an electroconductive material for imparting electroconductivity, and any other additive, etc. may be used in combination therewith to the extent that the effect of the present disclosure is not impaired. In addition, as those constituent materials, materials appropriately selected from ones known in the field of electroconductive members for electrophotography, and materials that may be utilized as such electroconductive members may be used.

<Binder Resin>

A known binder resin may be used as the binder resin for forming the electroconductive surface layer. Examples thereof may include resins and rubbers, such as a natural rubber, a product obtained by subjecting the natural rubber to vulcanization treatment, and a synthetic rubber. As the resin, for example, a fluororesin, a polyamide resin, an acrylic resin, a polyurethane resin, a silicone resin, a butyral resin, a styrene-ethylene/butylene-olefin copolymer, or an olefin-ethylene/butylene-olefin copolymer may be used. The binder resins may be used alone or in combination of two or more kinds. Among those, the binder resin is preferably a resin containing an aliphatic polycarbonate structure because of flexibility resulting from a reduction in universal hardness of the surface layer. Specifically, polycarbonate-based polyurethane obtained by copolymerizing an aliphatic polycarbonate polyol and a polyisocyanate is preferred.

Examples of the aliphatic polycarbonate polyol include polynonamethylene carbonate diol, poly(2-methyl-octamethylene) carbonate diol, polyhexamethylene carbonate diol, polypentamethylene carbonate diol, poly(3-methylpentamethylene) carbonate diol, polytetramethylene carbonate diol, polytrimethylene carbonate diol, poly(1,4-cyclohexanedimethylene carbonate) diol, poly(2-ethyl-2-butyl-trimethylene) carbonate diol, and random/block copolymers thereof.

The polyisocyanate is selected from generally-used known polyisocyanates, and examples thereof include toluene diisocyanate (TDI), diphenylmethane diisocyanate (MDI), polymeric diphenylmethane polyisocyanate, hydrogenated MDI, xylylene diisocyanate (XDI), hexamethylene diisocyanate (HDI), and isophorone diisocyanate (IPDI). Among those, aromatic isocyanates, such as toluene diisocyanate (TDI), diphenylmethane diisocyanate (MDI), and polymeric diphenylmethane polyisocyanate are more suitably used.

<Electroconductive Material>

A material similar to the electroconductive material that may be used in the electroconductive elastic layer described above may be used as the electroconductive material for imparting electroconductivity to the electroconductive surface layer.

<Resin Particles>

Roughening particles may be added to the electroconductive surface layer. Examples of the roughening particles include the following ones. With regard to a material for the roughening particles, organic insulating particles, for example, resins known in the field of electroconductive members for electrophotography, an acrylic resin, a polycarbonate resin, a styrene resin, a urethane resin, a fluororesin, and a silicone resin; and inorganic insulating particles of, for example, titanium oxide, silica, alumina, magnesium oxide, strontium titanate, barium titanate, barium sulfate, calcium carbonate, mica, zeolite, and bentonite may be used. In the present disclosure, organic insulating particles having flexibility, which do not impair the flexibility of the outermost surface, are preferably used as the roughening particles. Those particles may be used alone or in combination of two or more kinds.

<Thickness of Electroconductive Surface Layer>

The electroconductive surface layer preferably has a thickness of 0.1 to 100 The thickness is more preferably 1 to 50 The thickness of the surface layer may be measured by cutting out a cross-section of the roller with a sharp cutting tool and observing the cross-section by an optical microscope or an electron microscope.

<Method of Producing Electroconductive Surface Layer>

A method of forming the electroconductive surface layer is not particularly limited, but is, for example, spraying, dipping, or roll coating with a coating material obtained by adding a solvent to raw materials. A dip coating method is simple and excellent in production stability as the method of forming the electroconductive surface layer. In addition, after coating, additional treatment such as heating may be performed as required.

[Process Cartridge and Electrophotographic Apparatus]

The process cartridge of the present disclosure may integrally support, in addition to the electrophotographic photosensitive member described above and a developing member, at least one unit selected from the group consisting of: a charging unit; a transfer unit; and a cleaning unit, and be removably mounted onto the main body of an electrophotographic apparatus.

In addition, an electrophotographic apparatus of the present disclosure includes a process cartridge including the electrophotographic photosensitive member described above and a developing member, and may further include a charging unit, an exposing unit, and a transfer unit. The process cartridge has a feature of including: an electrophotographic photosensitive member; a toner; and a developing member configured to supply the toner to the electrophotographic photosensitive member, wherein the electrophotographic photosensitive member includes a surface layer containing: a particle A containing a metal atom; and a binder resin, wherein the toner includes a hydrotalcite particle as an external additive, wherein, in filter fitting analysis in STEM-EDS analysis, the hydrotalcite particle comprises fluorine, and wherein, when a number-average primary particle diameter of the particle A is represented by “m” [nm], a content volume ratio of the particle A with respect to the surface layer is represented by “p” [vol %], and a number-average primary particle diameter of the hydrotalcite particle is represented by “h” [nm], the “m”, the “p”, and the “h” satisfy the following expressions (1) to (3), respectively.

5≤m≤300 Expression (1);

5≤p≤40 Expression (2); and

60≤h≤1,000 Expression (3).

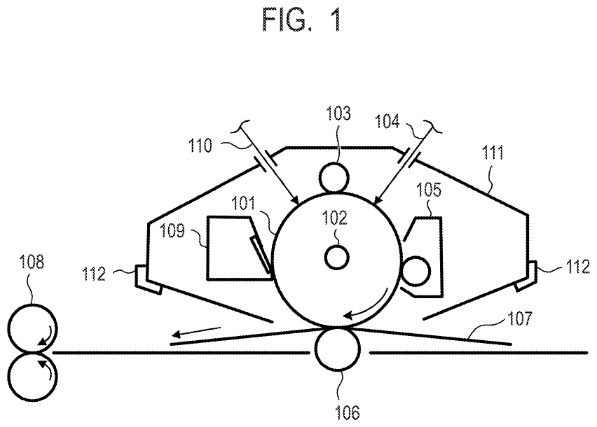

FIG. 1 shows an example of the schematic configuration of an electrophotographic apparatus including a process cartridge with an electrophotographic photosensitive member.

A cylindrical electrophotographic photosensitive member 101 is rotationally driven about a shaft 102 in a direction indicated by the arrow at a predetermined peripheral speed. The surface of the electrophotographic photosensitive member 101 is charged to a predetermined positive or negative potential by a charging unit 103. In FIG. 1, a roller charging system based on a roller-type charging member (charging roller) is shown, but a charging system, such as a corona charging system, a proximity charging system, or an injection charging system, may be adopted. The charged surface of the electrophotographic photosensitive member 101 is irradiated with image exposure light 104 from an exposing unit (not shown), and hence an electrostatic latent image corresponding to target image information is formed thereon. The electrostatic latent image formed on the surface of the electrophotographic photosensitive member 101 is developed with a toner stored in a developing unit 105, and hence a toner image is formed on the surface of the electrophotographic photosensitive member 101. The toner image formed on the surface of the electrophotographic photosensitive member 101 is transferred onto a transfer material 107 by a transfer unit 106. The transfer material 107 onto which the toner image has been transferred is conveyed to a fixing unit 108, and is subjected to treatment for fixing the toner image, and is printed out to the outside of the electrophotographic apparatus. The electrophotographic apparatus may include a cleaning unit 109 for removing a deposit such as the toner remaining on the surface of the electrophotographic photosensitive member 101 after the transfer. In addition, a so-called cleaner-less system configured to remove the deposit with the developing unit or the like without separate arrangement of the cleaning unit may be used. The electrophotographic apparatus may include an electricity-removing mechanism configured to subject the surface of the electrophotographic photosensitive member 101 to electricity-removing treatment with pre-exposure light 110 from a pre-exposing unit (not shown). In addition, a guiding unit 112 such as a rail may be arranged for removably mounting a process cartridge 111 of the present disclosure onto the main body of an electrophotographic apparatus.

The following model is conceivable so that the size, spacing, and presence amount of the particle A exposed on the surface layer of the electrophotographic photosensitive member may fall within ranges more appropriate for the particle diameter of the hydrotalcite particle to be supplied onto the surface layer.

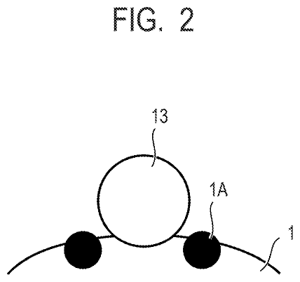

FIG. 2 shows a contact model between the surface of the photosensitive drum (electrophotographic photosensitive member) and a hydrotalcite particle 13, and a particle A inside the surface layer is represented by 1A. The following are considered as parameters: the number-average primary particle diameter of the particle A, which is represented by “m” [nm]; the content ratio of the particle A with respect to the surface layer, which is represented by “p” [vol %]; the number-average primary particle diameter of a hydrotalcite particle, which is represented by “h” [nm]; and the interparticle distance “x” [nm] of the particle A. It is conceivable from FIG. 2 that a relationship of “x≤h” needs to be satisfied in order for the hydrotalcite particle to be brought into point contact with the particle A.

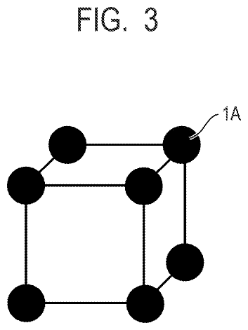

Now, such a cubic crystal as illustrated in FIG. 3 is considered in order to express the interparticle distance “x” of the particle A with the particle diameter “m” of the particle A and the content ratio “p” of the particle A. The volume of the cubic crystal, when represented by V, may be expressed as V=(x+m)³p. When this equation is solved with respect to “x”, the following is obtained: x=(V^{1/3}/m×p^{-1/3}−1)m. V^{1/3} actually depends on the presence state of the particle A (which is not actually a cubic crystal), and hence, when V^{1/3}/m is rounded as a coefficient “k”, the interparticle distance “x” may be expressed as x=k(p^{-1/3}−1)m. As a result of an investigation, the inventors have found that, in order to make the present disclosure more effective, the above-mentioned condition of “x≤h” in the case of k=2: 2(p^{-1/3}−1)m≤h is preferred. On the other hand, when “h” is excessively larger than “x”, a adverse effect such as the flowability of the toner being degraded as described above occurs. Accordingly, the inventors have also found through an investigation that, as the upper limit of “h”, the condition of “h≤x” in the case of k=20: h≤20(p^{-1/3}−1)m is preferred. That is, a suitable range for reducing tackiness without any other adverse effect in the present disclosure is represented by the following expression (4).

2(p^{-1/3}−1)m≤h≤20(p^{-1/3}−1)m Expression (4)

The electrophotographic photosensitive member of the present disclosure may be used for a laser beam printer, an LED printer, a copying machine, or the like.

### EXAMPLES

The present disclosure is described in more detail below by way of Examples and Comparative Examples. The present disclosure is by no means limited to the following Examples without departing from the gist of the present disclosure. In the description in the following Examples, “part(s)” is by mass unless otherwise specified.

<Production of Particles A>

### Preparation Example 1 of Particles A

10 g of titanium oxide (number-average primary particle diameter=50 nm) was added to 40 g of 2-butanol, and the mixture was dispersed using an US homogenizer for 60 minutes. Then, 0.3 g of a methyl hydrogen silicone oil “KF-99” (manufactured by Shin-Etsu Chemical Co., Ltd.) as a coupling agent and 10 mL of 2-butanol were added, and the mixture was further dispersed for 30 minutes using an US homogenizer. After the dispersion, the solvent was removed with an evaporator, and the residue was dried at 120° C. for 1 hour to produce [Particles 1].

### Preparation Examples 2 to 4 of Particles A

[Particles 2] to [Particles 4] were obtained in the same manner as in Preparation Example 1 of the particles A except that the kind of the particles to be used was changed as shown in Table 1.

### Preparation Example 5 of Particles A

Non-surface-treated titanium oxide (number-average primary particle diameter=50 nm) was used as [Particles 5].

### Preparation Example 6 of Particles A

To 100 parts by mass of titanium oxide (number-average primary particle diameter=5 nm), 10 parts by mass of a hole-transporting agent (the following formula (H)) was added, and 500 parts by mass of cyclohexanone was added. The mixture was dispersed using a wet media dispersion-type apparatus to provide [Particles 6].

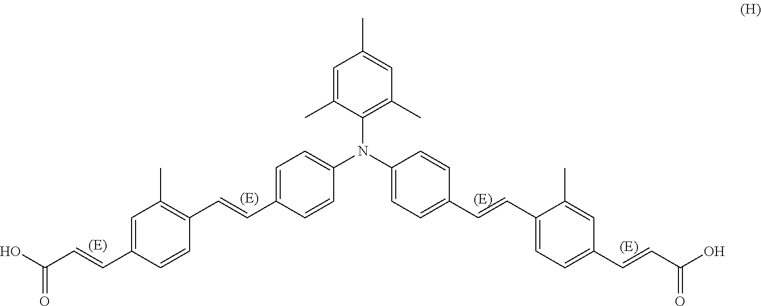 [SMILES: Cc1cc(C)c(N(c2ccc(/C=C/c3ccc(/C=C/C(=O)O)cc3C)cc2)c2ccc(/C=C/c3ccc(/C=C/C(=O)O)cc3C)cc2)c(C)c1]

### Preparation Example 7 of Particles A

10 g of titanium oxide (number-average primary particle diameter=40 nm) was added to 100 mL of ethanol, and the mixture was dispersed using an US homogenizer for 60 minutes. 0.5 g of a silane compound having a polymerizable functional group (the following formula (S)) and 10 mL of ethanol were added, and the mixture was dispersed using an US homogenizer for 30 minutes. The solvent was removed with an evaporator, and then the residue was heated at 120° C. for 1 hour to provide [Particles 7].

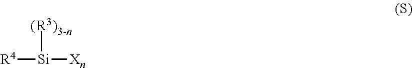

where R³ represents a hydrogen atom, an alkyl group having 1 to 10 carbon atoms, or an aralkyl group having 7 to 10 carbon atoms, R⁴ represents an organic group having an acryloyl group or a methacryloyl group, X represents a halogen atom, an alkoxy group, an acyloxy group, an aminooxy group, or a phenoxy group, and “n” represents an integer of from 1 to 3.

### Preparation Example 8 of Particles A

10 g of titanium oxide (number-average primary particle diameter=50 nm) was added to 100 mL of ethanol, and the mixture was dispersed using an US homogenizer for 60 minutes. 0.5 g of a silane compound having a polymerizable functional group (the above-mentioned formula (S)) and 10 mL of ethanol were added, and the mixture was dispersed using an US homogenizer for 30 minutes. The solvent was removed with an evaporator, and then the residue was heated at 120° C. for 1 hour to provide particles “a” subjected to surface treatment with the polymerizable functional group.

Next, 40 g of 2-butanol was added to 10 g of the resultant particles “a”, and the mixture was dispersed using an US homogenizer for 60 minutes. Then, 0.3 g of a methyl hydrogen silicone oil “KF-99” (manufactured by Shin-Etsu Chemical Co., Ltd.) as a coupling agent and 10 mL of 2-butanol were added, and the mixture was further dispersed for 30 minutes using an US homogenizer. After the dispersion, the solvent was removed with an evaporator, and the residue was dried at 120° C. for 1 hour to produce [Particles 8].

### Preparation Example 9 of Particles A

[Particles 9] were obtained in the same manner as in Preparation Example 7 of the particles A except that: the metal oxide was changed to tin oxide (number-average primary particle diameter=20 nm); and the silane compound having a polymerizable functional group was changed to a compound represented by the above-mentioned formula (S) in which R⁴ represented an organic group having a styryl group.

### Preparation Examples 10 to 28 of Particles A

[Particles 10] to [Particles 28] were obtained in the same manner as in Preparation Example 1 of the particles A except that the particles to be used were changed as shown in Table 1.

TABLE 1

| Particles A | Kind | Number-average primary particle diameter [nm] |
|---|---|---|
| Particles 1 | TiO₂ | 50 |
| Particles 2 | BaSO₄ | 8 |
| Particles 3 | FeO | 300 |
| Particles 4 | TiO₂ | 100 |
| Particles 5 | TiO₂ | 50 |
| Particles 6 | TiO₂ | 5 |
| Particles 7 | TiO₂ | 40 |
| Particles 8 | TiO₂ | 50 |
| Particles 9 | SnO₂ | 100 |
| Particles 10 | SnO₂ | 100 |
| Particles 11 | SnO₂ | 250 |
| Particles 12 | SnO₂ | 300 |
| Particles 13 | SnO₂ | 50 |
| Particles 14 | SnO₂ | 80 |
| Particles 15 | SnO₂ | 10 |
| Particles 16 | SnO₂ | 8 |
| Particles 17 | SnO₂ | 20 |
| Particles 18 | SnO₂ | 5 |
| Particles 19 | SnO₂ | 30 |
| Particles 20 | SnO₂ | 200 |
| Particles 21 | SnO₂ | 300 |
| Particles 22 | SnO₂ | 90 |
| Particles 23 | SnO₂ | 10 |
| Particles 24 | SnO₂ | 8 |
| Particles 25 | SnO₂ | 300 |
| Particles 26 | SnO₂ | 500 |
| Particles 27 | SnO₂ | 400 |
| Particles 28 | SnO₂ | 50 |

<Production of Electrophotographic Photosensitive Member>

(Production of Electrophotographic Photosensitive Member 1)

<Support>

An aluminum cylinder having a diameter of 24 mm and a length of 246 mm (JIS-A3003, aluminum alloy) was used as a support.

<Electroconductive Layer>

Next, the following materials were prepared.

| | |
|---|---|
| Titanium oxide (TiO₂) particles (average primary | 214 parts |
| particle diameter: 230 nm) coated with oxygen-deficient | |
| tin oxide (SnO₂), as metal oxide particles | |
| Phenol resin (monomer/oligomer of a phenol resin) | 132 parts |
| (product name: PLYOPHEN J-325, manufactured by | |
| Dainippon Ink and Chemicals, Incorporated, resin solid | |
| content: 60 mass %) as a binding material | |
| 1-Methoxy-2-propanol as a solvent | 98 parts |

Those materials were placed in a sand mill using 450 parts of glass beads each having a diameter of 0.8 mm, and were subjected to dispersion treatment under the conditions of a rotation speed of 2,000 rpm, a dispersion treatment time of 4.5 hours, and a preset temperature of cooling water of 18° C. to provide a dispersion liquid. The glass beads were removed from the dispersion liquid with a mesh (aperture: 150 μm).

A surface roughness-imparting material was added to the dispersion liquid at 10 mass % with respect to the total mass of the metal oxide particles and the binding material in the dispersion liquid after the removal of the glass beads. Silicone resin particles (product name: TOSPEARL 120, manufactured by Momentive Performance Materials, average particle diameter: 2 μm) were used as the surface roughness-imparting material.

In addition, a silicone oil (product name: SH28PA, manufactured by Dow Corning Toray Co., Ltd.) as a leveling agent was added to the dispersion liquid so as to 0.01 mass % with respect to the total mass of the metal oxide particles and the binding material in the dispersion liquid.

Next, a mixed solvent of methanol and 1-methoxy-2-propanol (mass ratio: 1:1) was added to the dispersion liquid so that the total mass of the metal oxide particles, the binding material, and the surface roughness-imparting material (i.e., the mass of solid content) in the dispersion liquid became 67 mass % with respect to the mass of the dispersion liquid. The resultant was stirred to prepare a coating liquid for an electroconductive layer of an electrophotographic photosensitive member.

The coating liquid for an electroconductive layer of an electrophotographic photosensitive member was applied onto the support by dip coating, and the resultant was heated at 140° C. for 1 hour to form an electroconductive layer of an electrophotographic photosensitive member, which had a thickness of 30

<Undercoat Layer>

Next, the following materials were prepared.

100 Parts of rutile-type titanium oxide particles (product name: MT-600BB, average primary particle diameter: 50 nm, manufactured by Tayca Corporation) were stirred and mixed with 500 parts of toluene, and 4.5 parts of vinyltrimethoxysilane (product name: KBM-1003, manufactured by Shin-Etsu Chemical Co., Ltd.) was added to the mixture, followed by stirring for 8 hours. After that, toluene was evaporated by distillation under reduced pressure, and the residue was dried at 120° C. for 3 hours. Thus, rutile-type titanium oxide particles whose surfaces had already been treated with vinyltrimethoxysilane were obtained.

18 Parts of the rutile-type titanium oxide particles whose surfaces had already been treated with vinyltrimethoxysilane, 4.5 parts of N-methoxymethylated nylon (product name: TORESIN EF-30T, manufactured by Nagase ChemteX Corporation), and 1.5 parts of a copolymerized nylon resin (product name: AMILAN CM8000, manufactured by Toray Industries, Inc.) were added to a mixed solvent of 90 parts of methanol and 60 parts of 1-butanol to prepare a dispersion liquid.

The dispersion liquid was subjected to dispersion treatment for 5 hours with a vertical sand mill using glass beads each having a diameter of 1.0 mm to prepare a coating liquid for an undercoat layer. The coating liquid for an undercoat layer was applied onto the electroconductive layer by dip coating, and the resultant coating film was dried at 100° C. for 10 minutes to form an undercoat layer having a thickness of 2.0

<Charge-Generating Layer>

Next, the following materials were prepared.

| | |
|---|---|
| Hydroxygallium phthalocyanine of a crystal form | 10 parts |
| having peaks at positions of 7.5º and 28.4º in a chart | |
| obtained by CuKα characteristic X-ray diffraction | |
| Polyvinyl butyral resin (product name: S-LEC BX-1, | 5 parts |
| manufactured by Sekisui Chemical Co., Ltd.) | |

Those materials were added to 200 parts of cyclohexanone, and the mixture was dispersed with a sand mill apparatus using glass beads each having a diameter of 0.9 mm for 6 hours.

The dispersion was diluted by further adding 150 parts of cyclohexanone and 350 parts of ethyl acetate thereto to provide a coating liquid for a charge-generating layer. The resultant coating liquid was applied onto the undercoat layer by dip coating, and was dried at 95° C. for 10 minutes to form a charge-generating layer having a thickness of 0.20 μm.

X-ray diffraction measurement was performed under the following conditions.

[(Powder X-ray Diffraction Measurement)]

Measurement apparatus used: X-ray diffraction apparatus RINT-TTRII manufactured by Rigaku Corporation
X-ray tube bulb: Cu
Tube voltage: 50 KV
Tube current: 300 mA
Scan method: 2θ/θ scan
Scan speed: 4.0°/min
Sampling interval: 0.02°
Start angle (2θ): 5.0°
Stop angle (2θ): 40.0°
Attachment: standard sample holder
Filter: not used
Incident monochrometer: used
Counter monochrometer: not used
Divergence slit: open
Divergence vertical limit slit: 10.00 mm
Scattering slit: open
Light-receiving slit: open
Flat plate monochrometer: used
Counter: scintillation counter

<Charge-Transporting Layer>

Next, the following materials were prepared.

| | | |
|---|---|---|
| (4,4′-Dimethyl-4″-(β-phenylstyryl)triphenylamine) | 8 | parts |
| Polycarbonate (product name: Iupilon Z400, manufactured | 10 | parts |
| by Mitsubishi Engineering-Plastics Corporation) | | |
| Silicone oil | 0.04 | part |
| (KF-54: manufactured by Shin-Etsu Chemical Co., Ltd.) | | |

Those materials were dissolved in a mixed solvent of 64 parts of tetrahydrofuran and 16 parts of toluene to prepare a coating liquid for a charge-transporting layer. The coating liquid for a charge-transporting layer was applied onto the charge-generating layer by dip coating to form a coating film, and the coating film was dried at 110° C. for 60 minutes to form a charge-transporting layer having a thickness of 20 μm.

<Surface Layer>

<Production of [Electrophotographic Photosensitive Member 1]>

Next, the following materials were prepared.

Coating Liquid 1 for Surface Layer

| | | |
|---|---|---|
| [Particles 1] | 7.2 | parts |
| Curable monomer: the following formula (M) | 10.0 | parts |
| Solvent: 1-propyl alcohol | 40.0 | parts |

The above-mentioned components were dispersed using a sand mill for 10 hours. After that, 1.0 part of a polymerization initiator (the following formula (I)) was added, and the contents were mixed and stirred to dissolution under a light-shielding condition to prepare a coating liquid for a surface layer (placed under a light-shielding condition during storage). The coating liquid for surface layer was applied onto the charge-transporting layer of the electrophotographic photosensitive member whose production had proceeded up to the charge-transporting layer in advance through use of a circular slide hopper coater. After the application, the resultant was dried at room temperature for 20 minutes, and then the electrophotographic photosensitive member was irradiated with a metal halide lamp (500 nW) for 1 minute while being rotated at a position of 100 nm to form a surface layer having a thickness of 2.0

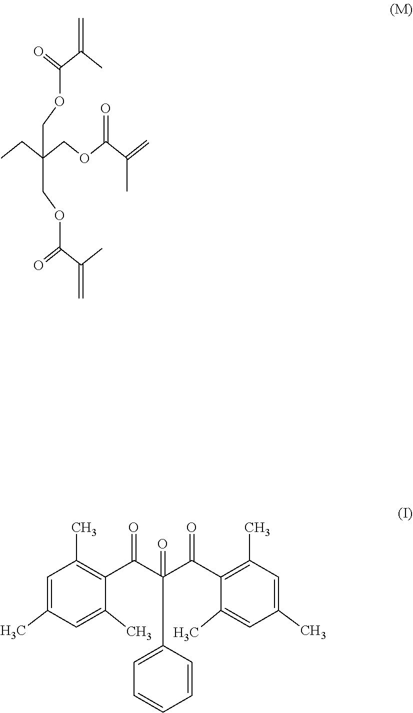

<Analysis of Surface Layer of Electrophotographic Photosensitive

Member>

The identification of the kind of the particles A in the surface layer, and the measurement of their number-average primary particle diameter and content ratio may be performed as described below.

Five 5 mm square sections were cut out of the electrophotographic photosensitive member produced in the foregoing to prepare five sample pieces for observation for each electrophotographic photosensitive member.

First, with use of one sample piece for each electrophotographic photosensitive member, the surface layer was sliced to a thickness of 150 nm by an FIB-μ, sampling method using a focused ion beam processing-observing apparatus (product name: FB-2000A, manufactured by Hitachi High-Tech Manufacturing & Service Corporation), and composition analysis of the surface layer was performed using a field emission electron microscope (HRTEM) (product name: JEM-2100F, manufactured by JEOL Ltd.) and an energy-dispersive X-ray analyzer (EDX) (product name: JED-2300T, manufactured by JEOL Ltd.). The measurement conditions of EDX are an acceleration voltage of 200 kV and a beam diameter of 1.0 nm.

Based on the resultant EDX image, the kind of the particles A was identified, and in addition, the diameter of a core was determined for each of 100 particles, and the average primary particle diameter was calculated from the arithmetic average thereof.

Next, for each electrophotographic photosensitive member, the remaining four sample pieces were used to reconstruct the surface layer into a three-dimensional object of 2 μm×2 μm×2 μm with Slice & View of FIB-SEM. Based on a difference in contrast of Slice & View of FIB-SEM, the content of the particles in the total volume of the surface layer was calculated. In this Example, the conditions of Slice & View were set as described below.

Sample Processing for Analysis: FIB Method
Processing and observation apparatus: NVision 40 manufactured by SII/Zeiss
Slice interval: 10 nm
Observation conditions:
   Acceleration voltage: 1.0 kV
   Sample tilt: 54°
   WD: 5 mm
   Detector: BSE detector
   Aperture: 60 high current
   ABC: ON
   Image resolution: 1.25 nm/pixel

An analysis region is set to 2 μm long by 2 μm wide, and information for each cross-section is integrated to determine a volume V per 2 μm in length×2 μm in width×2 μm in thickness (8 μm³). In addition, a measurement environment has a temperature of 23° C. and a pressure of 1×10⁻⁴ Pa. Strata 400S manufactured by FEI (sample tilt: 52°) may also be used as a processing and observation apparatus. In addition, the information for each cross-section was obtained through image analysis of the area of an identified particle. The image analysis was performed using the image processing software: Image-Pro Plus manufactured by Media Cybernetics.

Based on the resultant information, the volume V of the particles in a volume of 2 μm×2 μm×2 μm (unit volume: 8 μm³) was determined in each of the four sample pieces. Then, (V μm³/8 μm³×100) was calculated. The average of the (V μm³/8 μm³×100) values for the four sample pieces was defined as the content [vol %] of the particles in the surface layer with respect to the total volume of the surface layer.

<Production of [Electrophotographic Photosensitive Member 2] and [Electrophotographic Photosensitive Member 3]>

[Electrophotographic Photosensitive Member 2] and [Electrophotographic Photosensitive Member 3] were produced in the same manner as [Electrophotographic Photosensitive Member 1] except that, in the production of the surface layers of [Electrophotographic Photosensitive Member 2] and [Electrophotographic Photosensitive Member 3], the particles A were changed as shown in Table 2.

<Production of [Electrophotographic Photosensitive Member 4]>

(Coating Liquid 2 for Surface Layer)

| | |
|---|---|
| [Particles 4] | 7.2 parts |
| Polycarbonate resin (Z300: manufactured by | 10.0 parts |
| Mitsubishi Gas Chemical Company, Inc.) | |
| Solvent: 1-propyl alcohol | 40.0 parts |

The above-mentioned components were stirred to prepare a coating liquid 2 for a surface layer. The coating liquid 2 for a surface layer was applied onto the electrophotographic photosensitive member whose production had proceeded up to the charge-transporting layer in advance through use of a circular slide hopper coater to apply a surface layer onto the charge-transporting layer. Then, the resultant was dried at 110° C. for 70 minutes to produce a surface layer having a dry thickness of 2.0 μm.

<Production of [Electrophotographic Photosensitive Member 5] to [Electrophotographic Photosensitive Member 30]>

[Electrophotographic Photosensitive Member 5] to [Electrophotographic Photosensitive Member 30] were produced in the same manner as [Electrophotographic Photosensitive Member 1] except that, in the production of the surface layers of [Electrophotographic Photosensitive Member 5] to [Electrophotographic Photosensitive Member 30], changes were made as shown in Table 2.

<Production of [Electrophotographic Photosensitive Member 31]>

[Electrophotographic Photosensitive Member 31] was produced in the same manner as [Electrophotographic Photosensitive Member 1] except that, in the production of the surface layer of [Electrophotographic Photosensitive Member 31], the coating liquid for a surface layer was produced without the incorporation of the particles A.

TABLE 2

| | Particles A | | | Content |
|---|---|---|---|---|
| | | | Number- | volume |
| | | | average | with |
| | | | primary | respect to |
| | | | particle | surface |
| Electrophotographic | | | diameter | layer |
| Photosensitive member | | Kind | [nm] | [%] |
| Electrophotographic | Particles 1 | TiO₂ | 50 | 20 |
| Photosensitive | | | | |
| member 1 | | | | |
| Electrophotographic | Particles 2 | BaSO₄ | 8 | 20 |
| Photosensitive | | | | |
| member 2 | | | | |
| Electrophotographic | Particles 3 | FeO | 300 | 20 |
| Photosensitive | | | | |
| member 3 | | | | |
| Electrophotographic | Particles 4 | TiO₂ | 100 | 20 |
| Photosensitive | | | | |
| member 4 | | | | |
| Electrophotographic | Particles 5 | TiO₂ | 50 | 5 |
| Photosensitive | | | | |
| member 5 | | | | |
| Electrophotographic | Particles 6 | TiO₂ | 5 | 5 |
| Photosensitive | | | | |
| member 6 | | | | |
| Electrophotographic | Particles 7 | TiO₂ | 40 | 5 |
| Photosensitive | | | | |
| member 7 | | | | |
| Electrophotographic | Particles 8 | TiO₂ | 50 | 20 |
| Photosensitive | | | | |
| member 8 | | | | |
| Electrophotographic | Particles 9 | SnO₂ | 50 | 20 |
| Photosensitive | | | | |
| member 9 | | | | |
| Electrophotographic | Particles 20 | SnO₂ | 200 | 5 |
| Photosensitive | | | | |
| member 10 | | | | |
| Electrophotographic | Particles 17 | SnO₂ | 20 | 40 |
| Photosensitive | | | | |
| member 11 | | | | |
| Electrophotographic | Particles 10 | SnO₂ | 100 | 40 |
| Photosensitive | | | | |
| member 12 | | | | |
| Electrophotographic | Particles 11 | SnO₂ | 250 | 40 |
| Photosensitive | | | | |
| member 13 | | | | |
| Electrophotographic | Particles 12 | SnO₂ | 300 | 20 |
| Photosensitive | | | | |
| member 14 | | | | |
| Electrophotographic | Particles 13 | SnO₂ | 50 | 20 |
| Photosensitive | | | | |
| member 15 | | | | |
| Electrophotographic | Particles 14 | SnO₂ | 80 | 20 |
| Photosensitive | | | | |
| member 16 | | | | |
| Electrophotographic | Particles 15 | SnO₂ | 10 | 20 |
| Photosensitive | | | | |
| member 17 | | | | |
| Electrophotographic | Particles 16 | SnO₂ | 8 | 20 |
| Photosensitive | | | | |
| member 18 | | | | |
| Electrophotographic | Particles 17 | SnO₂ | 20 | 5 |
| Photosensitive | | | | |
| member 19 | | | | |
| Electrophotographic | Particles 18 | SnO₂ | 5 | 5 |
| Photosensitive | | | | |
| member 20 | | | | |
| Electrophotographic | Particles 19 | SnO₂ | 30 | 5 |
| Photosensitive | | | | |
| member 21 | | | | |
| Electrophotographic | Particles 20 | SnO₂ | 200 | 5 |
| Photosensitive | | | | |
| member 22 | | | | |
| Electrophotographic | Particles 21 | SnO₂ | 300 | 5 |
| Photosensitive | | | | |
| member 23 | | | | |
| Electrophotographic | Particles 22 | SnO₂ | 90 | 40 |
| Photosensitive | | | | |
| member 24 | | | | |
| Electrophotographic | Particles 23 | SnO₂ | 10 | 40 |
| Photosensitive | | | | |
| member 25 | | | | |
| Electrophotographic | Particles 24 | SnO₂ | 8 | 40 |
| Photosensitive | | | | |
| member 26 | | | | |
| Electrophotographic | Particles 25 | SnO₂ | 300 | 40 |
| Photosensitive | | | | |
| member 27 | | | | |
| Electrophotographic | Particles 26 | SnO₂ | 500 | 40 |
| Photosensitive | | | | |
| member 28 | | | | |
| Electrophotographic | Particles 27 | SnO₂ | 400 | 40 |
| Photosensitive | | | | |
| member 29 | | | | |
| Electrophotographic | Particles 28 | SnO₂ | 50 | 50 |
| Photosensitive | | | | |
| member 30 | | | | |
| Electrophotographic | — | — | — | — |
| Photosensitive | | | | |
| member 31 | | | | |

<Production of Toner>

### Preparation Example of Resin Particle Dispersion Liquid 1

| | |
|---|---|
| Styrene | 70.0 parts |
| Butyl acrylate | 28.7 parts |
| Acrylic acid | 1.3 parts |
| n-Lauryl mercaptan | 3.2 parts |

The above-mentioned materials were loaded into a vessel and mixed by stirring. An aqueous solution of 1.5 parts of Neogen RK (manufactured by DKS Co. Ltd.) in 150.0 parts of ion-exchanged water was added to the solution and dispersed therein.

Further, under gentle stirring for 10 minutes, an aqueous solution of 0.3 part of potassium persulfate in 10.0 parts of ion-exchanged water was added to the resultant. After purging with nitrogen, emulsion polymerization was performed at 70° C. for 6 hours. After the completion of the polymerization, the reaction liquid was cooled to room temperature, and ion-exchanged water was added to the resultant to provide a resin particle dispersion liquid 1 having a solid content concentration of 12.5 mass % and a glass transition temperature of 48° C. The particle size distribution of resin particles contained in the resin particle dispersion liquid 1 was measured with a particle size measuring device (LA-920, manufactured by Horiba, Ltd.). As a result, the number-average particle diameter of the contained resin particles was found to be 0.2 μm. In addition, coarse particles each having a particle diameter of more than 1 μm were not observed.

### Preparation Example of Resin Particle Dispersion Liquid 2

| | |
|---|---|
| Styrene | 78.0 parts |
| Butyl acrylate | 20.7 parts |
| Acrylic acid | 1.3 parts |
| n-Lauryl mercaptan | 3.2 parts |

The above-mentioned materials were loaded into a vessel and mixed by stirring. An aqueous solution of 1.5 parts of Neogen RK (manufactured by DKS Co. Ltd.) in 150.0 parts of ion-exchanged water was added to the solution and dispersed therein.

Further, under gentle stirring for 10 minutes, an aqueous solution of 0.3 part of potassium persulfate in 10.0 parts of ion-exchanged water was added to the resultant. After purging with nitrogen, emulsion polymerization was performed at 70° C. for 6 hours. After the completion of the polymerization, the reaction liquid was cooled to room temperature, and ion-exchanged water was added to the resultant to provide a resin particle dispersion liquid 2 having a solid content concentration of 12.5 mass % and a glass transition temperature of 60° C. The particle size distribution of resin particles contained in the resin particle dispersion liquid 2 was measured with a particle size measuring device (LA-920, manufactured by Horiba, Ltd.). As a result, the number-average particle diameter of the contained resin particles was found to be 0.2 μm. In addition, coarse particles each having a particle diameter of more than 1 μm were not observed.

### Preparation Example of Resin Particle Dispersion Liquid 3

| | |
|---|---|
| Styrene | 76.0 parts |
| Butyl acrylate | 22.7 parts |
| Acrylic acid | 1.3 parts |
| n-Lauryl mercaptan | 3.2 parts |

The above-mentioned materials were loaded into a vessel and mixed by stirring. An aqueous solution of 1.5 parts of Neogen RK (manufactured by DKS Co. Ltd.) in 150.0 parts of ion-exchanged water was added to the solution and dispersed therein.

Further, under gentle stirring for 10 minutes, an aqueous solution of 0.3 part of potassium persulfate in 10.0 parts of ion-exchanged water was added to the resultant. After purging with nitrogen, emulsion polymerization was performed at 70° C. for 6 hours. After the completion of the polymerization, the reaction liquid was cooled to room temperature, and ion-exchanged water was added to the resultant to provide a resin particle dispersion liquid 3 having a solid content concentration of 12.5 mass % and a glass transition temperature of 58° C. The particle size distribution of resin particles contained in the resin particle dispersion liquid 3 was measured with a particle size measuring device (LA-920, manufactured by Horiba, Ltd.). As a result, the number-average particle diameter of the contained resin particles was found to be 0.2 μm. In addition, coarse particles each having a particle diameter of more than 1 μm were not observed.

### Preparation Example of Release Agent Dispersion Liquid 1

100.0 Parts of behenyl behenate (melting point: 72.1° C.) and 15.0 parts of Neogen RK were mixed with 385.0 parts of ion-exchanged water and dispersed therein for about 1 hour with a wet jet mill JN100 (manufactured by Jokoh Co., Ltd.). Thus, a release agent dispersion liquid 1 was obtained. The wax concentration of the release agent dispersion liquid 1 was 20.0 mass %. The particle size distribution of release agent particles contained in the release agent dispersion liquid 1 was measured with a particle size measuring device (LA-920, manufactured by Horiba, Ltd.). As a result, the number-average particle diameter of the contained release agent particles was found to be 0.35 μm. In addition, coarse particles each having a particle diameter of more than 1 μm were not observed.

### Preparation Example of Release Agent Dispersion Liquid 2

100.0 Parts of a hydrocarbon-based wax HNP-9 (manufactured by Nippon Seiro Co., Ltd., melting point: 75.5° C.) and 15 parts of Neogen RK were mixed with 385.0 parts of ion-exchanged water and dispersed therein for about 1 hour with a wet jet mill JN100 (manufactured by Jokoh Co., Ltd.). Thus, a release agent dispersion liquid 2 was obtained. The wax concentration of the release agent dispersion liquid 2 was 20.0 mass %. The particle size distribution of release agent particles contained in the release agent dispersion liquid 2 was measured with a particle size measuring device (LA-920, manufactured by Horiba, Ltd.). As a result, the number-average particle diameter of the contained release agent particles was found to be 0.35 μm. In addition, coarse particles each having a particle diameter of more than 1 μm were not observed.

### Preparation Example of Colorant Dispersion Liquid 1

50.0 Parts of copper phthalocyanine (Pigment Blue 15:3) as a colorant and 5.0 parts of Neogen RK were mixed with 200.0 parts of ion-exchanged water and dispersed therein for about 1 hour with a wet jet mill JN100. Thus, a colorant dispersion liquid 1 was obtained. The solid content concentration of the colorant dispersion liquid 1 was 20.0 mass %. The particle size distribution of colorant particles contained in the colorant dispersion liquid 1 was measured with a particle size measuring device (LA-920, manufactured by Horiba, Ltd.). As a result, the number-average particle diameter of the contained colorant particles was found to be 0.20 μm. In addition, coarse particles each having a particle diameter of more than 1 μm were not observed.

<Method of Producing [Toner Particles 1]>

| | |
|---|---|
| Resin particle dispersion liquid 1: | 265.0 parts |
| Release agent dispersion liquid 1: | 10.0 parts |
| Release agent dispersion liquid 2: | 8.0 parts |
| Colorant dispersion liquid 1: | 8.0 parts |

As a core-forming step, the above-mentioned materials were loaded into a round flask made of stainless steel, and were mixed. Subsequently, the mixture was dispersed using a homogenizer (manufactured by IKA: ULTRA-TURRAX T50) at 5,000 r/min for 10 minutes. While the mixture was stirred, the temperature in the container was adjusted to 30° C., and a 1 mol/L aqueous solution of sodium hydroxide was added to adjust the pH to 8.0.

As an aggregating agent, an aqueous solution obtained by dissolving 0.25 part of aluminum chloride in 10.0 parts of ion-exchanged water was added to the mixture at 30° C. under stirring over 10 minutes. After the mixture had been left to stand for 3 minutes, a temperature increase was started, and the temperature was increased to 60° C. to perform production of aggregated particles (formation of cores). The volume-based median diameter of the formed aggregated particles was checked as appropriate using “Coulter Counter Multisizer 3” (trademark, manufactured by Beckman Coulter, Inc.). At the time point when the volume-based median diameter reached 7.0 μm, as a shell-forming step, 15.0 parts of the resin particle dispersion liquid 2 was added, and the mixture was further stirred for 1 hour to form shells.

After that, a 1 mol/L aqueous solution of sodium hydroxide was added to adjust the pH to 9.0, and then the temperature was increased to 95° C. to perform spheroidization of the aggregated particles. When an average circularity of 0.980 was achieved, a temperature decrease was started, and cooling was performed to room temperature to provide a toner particle dispersion liquid 1.

Hydrochloric acid was added to the resultant toner particle dispersion liquid 1 to adjust the pH to 1.5 or less, and the mixture was left to stand under stirring for 1 hour and then subjected to solid-liquid separation with a pressure filter to provide a toner cake. The toner cake was re-slurried with ion-exchanged water to be turned into a dispersion liquid again, followed by solid-liquid separation with the above-mentioned filter. Re-slurrying and solid-liquid separation were repeated until the electrical conductivity of the filtrate became 5.0 μS/cm or less. After that, the resultant was finally subjected to solid-liquid separation to provide a toner cake. The resultant toner cake was dried, and was classified using a classifier so as to have a volume-based median diameter of 7.0 μm. Thus, [Toner Particles 1] were obtained.

<Method of Producing [Toner Particles 2]>

| | |
|---|---|
| Resin particle dispersion liquid 3: | 265.0 parts |
| Release agent dispersion liquid 1: | 10.0 parts |
| Release agent dispersion liquid 2: | 8.0 parts |
| Colorant dispersion liquid: | 8.0 parts |

As a core-forming step, the above-mentioned materials were loaded into a round flask made of stainless steel, and were mixed. Subsequently, the mixture was dispersed using a homogenizer (manufactured by IKA: ULTRA-TURRAX T50) at 5,000 r/min for 10 minutes. While the mixture was stirred, the temperature in the container was adjusted to 30° C., and a 1 mol/L aqueous solution of sodium hydroxide was added to the mixture to adjust the pH to 8.0.

As an aggregating agent, an aqueous solution obtained by dissolving 0.25 part of aluminum chloride in 10.0 parts of ion-exchanged water was added at 30° C. under stirring over 10 minutes. After the mixture had been left to stand for 3 minutes, a temperature increase was started, and the temperature was increased to 60° C. to perform production of aggregated particles (formation of cores). The volume-based median diameter of the formed aggregated particles was checked as appropriate using “Coulter Counter Multisizer 3” (trademark, manufactured by Beckman Coulter, Inc.). At the time point when the volume-based median diameter reached 7.0 μm, a 1 mol/L aqueous solution of sodium hydroxide was added to adjust the pH to 9.0, and then the temperature was increased to 95° C. to perform spheroidization of the aggregated particles.

<Preparation of [Hydrotalcite Particles 1]>

A mixed aqueous solution (solution A) of 1.03 mol/L magnesium chloride and 0.239 mol/L aluminum sulfate, a 0.753 mol/L aqueous solution of sodium carbonate (solution B), and a 3.39 mol/L aqueous solution of sodium hydroxide (solution C) were prepared.

Next, the solution A, the solution B, and the solution C were injected into a reaction vessel with a metering pump at such a flow rate that the volume ratio “solution A: solution B” became 4.5:1, and the pH value of the reaction solution was kept in the range of from 9.3 to 9.6 with the solution C. The reaction was performed at a reaction temperature of 40° C. to generate precipitates. After filtration and washing, the resultant was subjected to re-emulsification in ion-exchanged water to provide a hydrotalcite slurry as a raw material. The concentration of hydrotalcite in the resultant hydrotalcite slurry was 5.6 mass %. The resultant hydrotalcite slurry was dried in a vacuum overnight at 40° C. NaF was dissolved in ion-exchanged water so that the concentration became 100 mg/L, and the resultant was adjusted to pH 7.0 with 1 mol/L HCl or 1 mol/L NaOH. Then, the dried hydrotalcite was added to the prepared solution at 0.1% (w/v %). Constant-speed stirring was performed with a magnetic stirrer for 48 hours to the degree that the hydrotalcite was not settled out. After that, the resultant was filtered through a membrane filter having a pore diameter of 0.5 μm and washed with ion-exchanged water. The resultant hydrotalcite was dried in a vacuum overnight at 40° C. and then subjected to shredding treatment.

<Preparation of [Hydrotalcite Particles 2] to [Hydrotalcite Particles 8] and [Hydrotalcite Particles 10] to [Hydrotalcite Particles 18]>

[Hydrotalcite Particles 2] to [Hydrotalcite Particles 8] and [Hydrotalcite Particles 10] to [Hydrotalcite Particles 18] were obtained in the same manner as in the production example of [Hydrotalcite Particles 1] except that the volume ratio “solution A: solution B” and the conditions for the grinding treatment were adjusted as appropriate.

<Preparation of [Hydrotalcite Particles 9]>

A mixed aqueous solution (solution A) of 1.03 mol/L magnesium chloride and 0.239 mol/L aluminum sulfate, a 0.753 mol/L aqueous solution of sodium carbonate (solution B), and a 3.39 mol/L aqueous solution of sodium hydroxide (solution C) were prepared.

Next, the solution A, the solution B, and the solution C were injected into a reaction vessel with a metering pump at such a flow rate that the volume ratio “solution A: solution B” became 4.5:1, and the pH value of the reaction solution was kept in the range of from 9.3 to 9.6 with the solution C. The reaction was performed at a reaction temperature of 40° C. to generate precipitates. After filtration and washing, the resultant was subjected to re-emulsification in ion-exchanged water to provide a hydrotalcite slurry as a raw material. The concentration of hydrotalcite in the resultant hydrotalcite slurry was 5.6 mass %. The resultant hydrotalcite slurry was kept at 95° C., and 5 parts by mass of a fluorosilicone oil was added to the hydrotalcite slurry with respect to 95 parts by mass of the solid content, to thereby subject the hydrotalcite slurry to surface treatment. Then, the resultant was filtered and washed with water. Subsequently, the resultant was dried at 100° C. for 24 hours and grinded with an atomizer mill (manufactured by Dalton Corporation). Thus, [Hydrotalcite Particles 9] were obtained.

<Preparation of [Hydrotalcite Particles 19]>

[Hydrotalcite particles 19] were obtained in the same manner as in the production example of [Hydrotalcite Particles 1] except that ion-exchanged water was used instead of the NaF aqueous solution in the production example of [Hydrotalcite Particles 1].

The particle diameters of the obtained hydrotalcite particles are shown in Table 3.

TABLE 3

| | Average particle diameter |
|---|---|
| | [nm] |
| Hydrotalcite particles 1 | 400 |
| Hydrotalcite particles 2 | 80 |
| Hydrotalcite particles 3 | 900 |
| Hydrotalcite particles 4 | 200 |
| Hydrotalcite particles 5 | 300 |
| Hydrotalcite particles 6 | 100 |
| Hydrotalcite particles 7 | 1,000 |
| Hydrotalcite particles 8 | 500 |
| Hydrotalcite particles 9 | 100 |
| Hydrotalcite particles 10 | 70 |
| Hydrotalcite particles 11 | 800 |
| Hydrotalcite particles 12 | 60 |
| Hydrotalcite particles 13 | 150 |
| Hydrotalcite particles 14 | 5,000 |
| Hydrotalcite particles 15 | 2,000 |
| Hydrotalcite particles 16 | 3,000 |
| Hydrotalcite particles 17 | 4,000 |
| Hydrotalcite particles 18 | 15,400 |
| Hydrotalcite particles 19 | 400 |

<Production Example of [Toner 1]>

[Hydrotalcite Particles 1] (0.3 part) and silica particles 1 (RX200: primary average particle diameter: 12 nm, HMDS treatment, manufactured by Nippon Aerosil Co., Ltd.) (1.5 parts) were externally added to [Toner Particles 1] (100.0 parts) and mixed therewith by FM10C (manufactured by Nippon Coke & Engineering Co., Ltd.). Conditions for the external addition were as follows: an AO blade was used as a lower blade; the distance from the wall of a deflector was set to 20 mm; the loading amount of the toner particles was 2.0 kg; the number of revolutions was 66.6 s⁻¹; the external addition time was 10 minutes; and cooling water was set to a temperature of 20° C. and a flow rate of 10 L/min. After that, the resultant was sieved with a mesh having an aperture of 200 μm to provide [Toner 1].

### Production Examples of [Toner 2] to [Toner 19] and [Toner 22]

In the method of producing [Toner 1], the kind of the toner particles and the kind of the hydrotalcite particles were changed as shown in Table 4. [Toner 2] to [Toner 19] and [Toner 22] were produced in the same manner as in the method of producing [Toner 1] except for the foregoing.

### Production Example of [Toner 20]

[Toner 20] was obtained in the same manner as in the production example of [Toner 1] except that [Hydrotalcite Particles 1] were changed to polytetrafluoroethylene fine particles “Fluoro A” (manufactured by Shamrock Technologies, average particle diameter of primary particles: 0.3 μm).

### Production Example of [Toner 21]

[Toner 21] was obtained in the same manner as in the production example of [Toner 1] except that [Hydrotalcite Particles 1] were changed to fluorine-containing alumina particles.

The fluorine-containing alumina particles were produced in the following manner: alumina having a BET specific surface area of 120 m²/g was placed in a reaction chamber, and under a nitrogen atmosphere, a mixed solution of 8 parts of heptadecafluorodecyltrimethoxysilane and 1.8 parts of hexamethyldisilazane was sprayed with respect to 100 parts of stirred alumina particles, and the mixture was heated and stirred at 220° C. for 150 minutes, followed by cooling.

TABLE 4

| | | Hydrotalcite particles | |
|---|---|---|---|
| | | | Average |
| | | | particle |
| | | | diameter |
| | Toner particles | | [nm] |
| Toner 1 | Toner particles 1 | Hydrotalcite particles 1 | 400 |
| Toner 2 | Toner particles 2 | Hydrotalcite particles 2 | 80 |
| Toner 3 | | Hydrotalcite particles 3 | 900 |
| Toner 4 | | Hydrotalcite particles 4 | 200 |
| Toner 5 | | Hydrotalcite particles 5 | 300 |
| Toner 6 | | Hydrotalcite particles 6 | 100 |
| Toner 7 | | Hydrotalcite particles 7 | 1,000 |
| Toner 8 | | Hydrotalcite particles 8 | 500 |
| Toner 9 | | Hydrotalcite particles 9 | 100 |
| Toner 10 | | Hydrotalcite particles 10 | 70 |
| Toner 11 | | Hydrotalcite particles 11 | 800 |
| Toner 12 | | Hydrotalcite particles 12 | 60 |
| Toner 13 | | Hydrotalcite particles 13 | 150 |
| Toner 14 | | Hydrotalcite particles 14 | 5,000 |
| Toner 15 | | Hydrotalcite particles 15 | 2,000 |
| Toner 16 | | Hydrotalcite particles 16 | 3,000 |
| Toner 17 | | Hydrotalcite particles 17 | 4,000 |
| Toner 18 | | Hydrotalcite particles 18 | 15,400 |
| Toner 19 | | Hydrotalcite particles 19 | 400 |
| Toner 20 | | PTFE particles | 300 |
| Toner 21 | | Fluorine-containing | 12 |
| | | alumina particles | |
| Toner 22 | | Hydrotalcite particles 1 | 400 |

<Method of analyzing Each Element of Hydrotalcite Particles>

The analysis of each element of the hydrotalcite particles is performed by EDS mapping measurement of the toner using a scanning transmission electron microscope (STEM). In the EDS mapping measurement, each pixel of an analysis area has spectrum data. When a silicon drift detector having a large detection element area is used, EDS mapping can be measured with high sensitivity.

When statistical analysis is performed for the spectrum data on each pixel obtained by the EDS mapping measurement, main component mapping in which pixels having similar spectra are extracted can be obtained, enabling mapping with components identified.

A sample for observation is produced by the following procedure.

0.5 g of the toner is weighed, and is left to stand still in a mold of a columnar shape having a diameter of 8 mm at a load of 40 kN for 2 minutes using a Newton press to produce a toner pellet of a columnar shape having a diameter of 8 mm and a thickness of about 1 mm. A slice having a thickness of 200 nm is produced from the toner pellet with an ultramicrotome (Leica, FC7).

In STEM-EDS analysis, measurement was performed with the following apparatus and under the following conditions.

Measurement apparatus used 1: scanning transmission electron microscope; JEM-2800 manufactured by JEOL Ltd.

Measurement apparatus used 2: EDS detector; JED-2300T dry SD100GV detector (detection element area: 100 mm²) manufactured by JEOL Ltd.

Measurement apparatus used 3: EDS analyzer; NORAN System 7 manufactured by Thermo Fisher Scientific K.K.

(Conditions for STEM-EDS)
Acceleration voltage of STEM: 200 kV
Magnification: 20,000 times
Probe size: 1 nm
STEM image size; 1,024 pixels×1,024 pixels (an EDS element mapping image at the same position is obtained.)
EDS mapping size; 256 pixels×256 pixels, Dwell Time; 30 μs, number of scans; 100 frames

The calculation of the ratio of polyvalent metal elements in the toner particles and the ratio of each element in the hydrotalcite particles based on multivariate analysis is performed as described below.

The filter fitting analysis according to the present disclosure is described as follows.

EDS mapping is obtained with the above-mentioned STEM-EDS analyzer. Then, the collected spectrum mapping data is subjected to multivariate analysis through use of a COMPASS (PCA) mode among the measurement commands of the above-mentioned NORAN System 7 to extract a main component map image.

At that time, setting values are set as follows.
Kernel size: 3×3
Quantitative map setting: high (slow)
Filter fit type: high precision (slow)

At the same time, through this operation, the area ratio of each extracted main component in an EDS measurement field of view is calculated. The resultant EDS spectrum of each main component mapping is subjected to quantitative analysis by the Cliff-Lorimer method.

The toner particle portions and the hydrotalcite particles are distinguished from each other based on the results of the above-mentioned quantitative analysis of the resultant STEM-EDS main component mapping. Based on the size of a particle, the shape thereof, the contents of polyvalent metals, such as aluminum and magnesium, therein, and the amount ratio therebetween, the particle may be identified to be a hydrotalcite particle.

In addition, when fluorine is present in the hydrotalcite particle according to the following method, the particle may be judged to be a hydrotalcite particle containing fluorine.

(Method of Analyzing Fluorine Contained in Hydrotalcite Particles)

Based on the mapping data according to the STEM-EDS analysis obtained by the above-mentioned method, fluorine contained in the hydrotalcite particles is analyzed.

When the peak intensity of fluorine is 1.5 or more times as high as a background intensity in the EDS spectrum obtained from the main component map image of the particles extracted by COMPASS, it is judged that fluorine is contained in the particles.

<Method of measuring Number-Average Particle Diameter of Hydrotalcite Particles>

The number-average particle diameter of the hydrotalcite particles is measured using a scanning electron microscope “S-4800” (product name; manufactured by Hitachi, Ltd.). The toner having the external additive externally added thereto is observed, and the long diameters of 100 primary particles of the external additive are randomly measured in a field of view magnified up to a maximum of 200,000 times to determine the number-average particle diameter thereof. The observation magnification is appropriately adjusted depending on the size of the external additive. In this case, a particle that appears to be one particle in the observation is judged to be a primary particle.

<Method of analyzing Fluorine inside Hydrotalcite Particles>

Based on the mapping data according to the STEM-EDS analysis obtained by the above-mentioned method, analysis of fluorine inside the hydrotalcite particles is performed. Specifically, EDS line analysis in a direction normal to the surface of the particles is performed to analyze fluorine present thereinside.

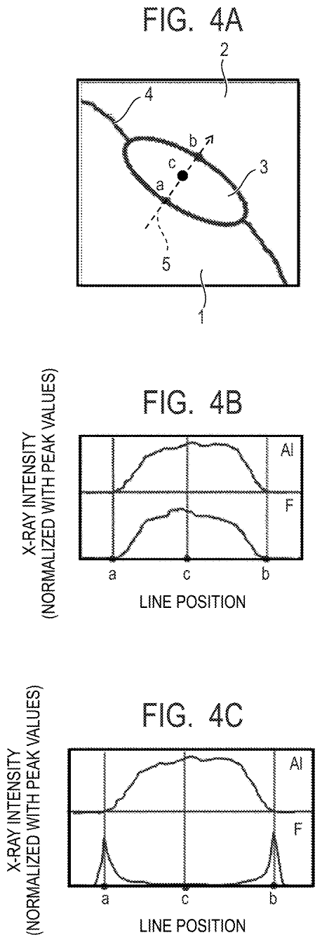

A schematic view of the line analysis is shown in FIG. 4A. In a hydrotalcite particle 3 adjacent to a toner particle 1 and a toner particle 2, line analysis is performed in a direction normal to the outer periphery of the hydrotalcite particle 3, that is, a direction 5. There is illustrated a boundary 4 between toner particles.

A range in an obtained STEM image where the particles of interest were present was selected with a rectangle selection tool, and the line analysis was performed under the following conditions.

(Line Analysis Conditions)
STEM magnification; 800,000 times
Line length; 200 nm
Line width; 30 nm
Number of line divisions; 100 (intensity measurement performed every 2 nm)

When the element peak intensity of fluorine is 1.5 or more times as high as the background intensity in the EDS spectrum of the hydrotalcite particle, and when the element peak intensity of fluorine at each of both ends of the hydrotalcite particle in the line analysis (a point “a” and a point “b” in FIG. 4A) is not more than 3.0 times as high as a peak intensity at a point “c”, it is judged that the element is contained inside the hydrotalcite particle. The point “c” is defined as the midpoint of a line segment ab (i.e., the midpoint of the above-mentioned both ends).

Examples of the X-ray intensity of fluorine obtained by the line analysis are shown in FIG. 4B and FIG. 4C. When the hydrotalcite particle contains fluorine inside, a graph of the X-ray intensity normalized with the peak intensities shows such a shape as shown in FIG. 4B. When the hydrotalcite particle contains fluorine derived from a surface treatment agent, as shown in FIG. 4C, the graph of the X-ray intensity normalized with the peak intensities has peaks near the points “a” and “b” at both ends in the graph of fluorine. When a fluorine-derived X-ray intensity in the line analysis is recognized, it may be recognized that the hydrotalcite particle contains fluorine inside.

<Production of Charging Roller>

### Production Example of [Charging Member 1]

<Preparation of Rubber Mixture for Molding of Electroconductive Elastic Layer>

Materials whose kinds and blending amounts were as shown in Table 5 were mixed with a 6 L pressure kneader (product name: TD6-15MDX, manufactured by Toshin Co., Ltd.) to provide an unvulcanized rubber mixture. The mixing was performed under the conditions of a filling ratio of 70 vol %, a blade rotation speed of 30 rpm, and 16 minutes.

TABLE 5

| | Material | Blending amount |
|---|---|---|
| | (product name, manufacturer) | (parts by mass) |
| Raw material | Hydrin rubber (EPICHLOMER | 50 |
| rubber | CG102, manufactured by | |
| | Osaka Soda Co., Ltd.) | |
| Raw material | Acrylonitrile rubber (N230SV, | 50 |
| rubber | manufactured by JSR Corporation) | |
| Electro- | Carbon black (TOKABLACK | 50 |
| conductive | #7360, Tokai Carbon Co., Ltd.) | |
| agent | | |
| Filler | Calcium carbonate (product name: | 45 |
| | NANOX #30, manufactured by | |
| | Maruo Calcium Co., Ltd.) | |
| Plasticizer | Aliphatic polyester plasticizer | 5 |
| | (product name: Polycizer P202, | |
| | manufactured by DIC Corporation) | |

Further, the unvulcanized rubber mixture obtained in the foregoing was mixed with materials whose kinds and blending amounts were as shown in Table 6 below in a mixer to prepare a rubber mixture for forming an electroconductive elastic layer. An open roll having a roll diameter of 12 inches was used as the mixer. The mixing was performed under the following conditions: the mixture was bilaterally cut 20 times in total at a front roll rotation speed of 10 rpm, a back roll rotation speed of 8 rpm, and a roll gap of 2 mm, and was then subjected to tight milling 10 times at a roll gap of 1.0 mm.

TABLE 6

| | Material | Blending amount |
|---|---|---|
| | (product name, manufacturer) | (parts by mass) |
| Raw material | Unvulcanized rubber mixture | 100 |
| rubber | | |
| Vulcanization | Zinc stearate (product name: | 1.5 |
| aid | ZINC STEARATE, | |
| | manufactured by NOF | |
| | Corporation) | |
| Vulcanization | Stearic acid (product name: | 2 |
| aid | STEARIC ACID CAMELLIA, | |
| | manufactured by NOF | |
| | Corporation) | |
| Vulcanizing | Sulfur (product name: SULFAX | 3 |
| agent | PMC, manufactured by | |
| | Tsurumi Chemical Industry Co., | |
| | Ltd.) | |

<Molding of Electroconductive Elastic Layer>

There was prepared a round bar having an overall length of 244 mm and an outer diameter of 6 mm obtained by subjecting the surface of free-cutting steel to electroless nickel plating treatment. Next, a roll coater was used to apply “METALOC U-20” (product name, manufactured by Toyokagaku Kenkyusho Co., Ltd.) as an adhesive to a 224 mm region of the round bar excluding both end portions each having a length of 10 mm over the entire circumference. In this Example, the round bar having the adhesive applied thereto was used as an electroconductive support.

Next, a die having an inner diameter of 10.0 mm was attached to the tip of a crosshead extruder having a mechanism for supplying an electroconductive support and a mechanism for discharging an unvulcanized rubber roller, and the temperature of each of the extruder and the crosshead, and the conveyance speed of the electroconductive support were adjusted to 100° C. and 60 mm/sec, respectively. Under those conditions, the rubber mixture for forming an electroconductive elastic layer was supplied from the extruder, and the outer peripheral portion of the electroconductive support was coated with the rubber mixture for forming an electroconductive elastic layer in the crosshead to provide an unvulcanized rubber roller.

Next, the unvulcanized rubber roller was loaded into a hot-air vulcanization furnace at 170° C., and was heated for 60 minutes to vulcanize the layer of the unvulcanized rubber composition, to thereby provide a roller having an electroconductive resin layer formed on the outer peripheral surface of the electroconductive support. After that, 12 mm each of both end portions of the electroconductive resin layer was cut off so that the length of the electroconductive resin layer portion in its longitudinal direction became 220 mm.

Finally, the surface of the electroconductive resin layer was ground with a rotary grindstone. Thus, a roller A with an electroconductive layer having a diameter of 8.5 mm at a position away from the central portion by 90 mm toward each of both end portion sides and having a central portion diameter of 8.6 mm was obtained.

<Molding of Electroconductive Surface Layer>

A coating liquid of a binder resin for forming an electroconductive surface layer was produced by the following technique. Under a nitrogen atmosphere, 100 parts by mass of a polyester polyol (product name: P3010, manufactured by Kuraray Co., Ltd.) was gradually added dropwise to 27 parts by mass of polymeric MDI (product name: Millionate MR200, manufactured by Nippon Polyurethane Industry Co., Ltd.) in a reaction vessel while the temperature in the reaction vessel was kept at 65° C. After the completion of the dropwise addition, the mixture was subjected to a reaction at a temperature of 65° C. for 2 hours. The resultant reaction mixture was cooled to room temperature to provide an isocyanate group-terminated prepolymer P-1 having an isocyanate group content of 4.3%.

With respect to 54.9 parts by mass of the isocyanate group-terminated prepolymer P-1, 41.52 parts by mass of another polyester polyol (product name: P2010, manufactured by Kuraray Co., Ltd.) and carbon black (MA230: manufactured by Mitsubishi Chemical Corporation, number-average particle diameter: 30 nm, 30 parts by mass) were dissolved in methyl ethyl ketone (MEK) so as to adjust the solid content to 27 mass %. Thus, a mixed liquid 1 was produced. 270 g of the mixed liquid 1 and 200 g of glass beads having an average particle diameter of 0.8 mm were placed in a glass bottle having an internal volume of 450 mL, and were dispersed using a paint shaker dispersing machine for 12 hours, and then 15 parts by mass of urethane particles having an average particle diameter of 7.0 μm (DAIMICBEAZ UCN-5070D: manufactured by Dainichiseika Color & Chemicals Mfg. Co., Ltd.) were added. After that, the mixture was further dispersed for 15 minutes, and the glass beads were removed to provide a coating liquid S-1 for a surface layer.

The roller A with an electroconductive layer was dipped in the coating liquid S-1 for a surface layer with its longitudinal direction being a vertical direction and its upper end portion being held, and was lifted, followed by air drying at 23° C. for 30 minutes. Then, the resultant was dried in a hot air-circulating dryer set to 80° C. for 1 hour, and further dried in a hot air-circulating dryer set to 160° C. for 1 hour to form a surface layer on the outer peripheral surface of the roller. In the dip coating, a dipping time was 9 seconds, and a roller-lifting speed was adjusted to 20 mm/sec as an initial speed and 2 mm/sec as a final speed, and the speed was linearly changed with time between 20 mm/sec and 2 mm/sec.

The roller produced by the above-mentioned technique was irradiated with UV light having a wavelength of 254 nm at a cumulative light quantity of 9,000 mJ/cm² to decompose the binder resin in the outermost surface of the surface layer. A low-pressure mercury lamp (manufactured by Harison Toshiba Lighting Corporation) was used for the irradiation with UV light. [Charging Member 1] was produced by the technique described above.

<Measurement of Universal Hardness>

The universal hardness at a position having a depth of 1 μm from the surface of the electroconductive surface layer was measured with a universal hardness meter. An ultramicrohardness meter (product name: FISCHERSCOPE HM-2000, manufactured by Helmut Fischer GmbH) was used for the measurement. Specific measurement conditions are shown below.
Measurement indenter: Vickers indenter (face angle: 136, Young's modulus: 1,140,
Poisson's ratio: 0.07, indenter material: diamond)
Measurement environment: temperature: 23° C., relative humidity: 50%
Maximum test load: 1.0 mN
Load condition: A load was applied in proportion to time at such a rate as to reach the maximum test load in 20 seconds.

In this evaluation, the universal hardness was calculated by the following calculation formula (1) using a load F at the time point when the indenter was pushed to a depth of 1 μm from the surface of the surface layer, and using a contact area A between the indenter and the surface layer at that time.

Universal hardness (N/mm²)=F/A Calculation formula (1)

The universal hardness of [Charging Member 1] of this Example was 3.4 N/mm².

### Production Example of [Charging Member 2]

An electroconductive surface layer was formed as described below on the roller A with an electroconductive layer of the production example of [Charging Member 1].

First, methyl isobutyl ketone was added to a caprolactone-modified acrylic polyol solution to adjust its solid content to 10 mass %. Materials shown in Table 7 below were used with respect to 1,000 parts by mass of the acrylic polyol solution (solid content: 100 parts by mass) to prepare a mixed solution. At this time, the mixture of blocked HDI and blocked IPDI was “NCO/OH=1.0”.

TABLE 7

| | Material | Blending amount |
|---|---|---|
| | (product name, manufacturer) | (parts by mass) |
| Main agent | Caprolactone-modified acrylic | 100 |
| | polyol solution (product | |
| | name: PLACCEL DC2016, | |
| | manufactured by Daicel | |
| | Chemical Industries, Ltd.) | |
| Curing agent | 7:3 mixture of HDI | 80.14 |
| | “DURANATE TPA-B80E” | |
| | (product name, manufactured by | |
| | Asahi Chemical Industry CO., | |
| | Ltd.) and IPDI “VESTANAT | |
| | B1370” (product name, | |
| | manufactured by Degussa-Hüls | |
| | AG) | |
| Electro- | Carbon black (product name: #52, | 20 |
| conductive | manufactured by Mitsubishi | |
| agent | Chemical Corporation) | |
| Additive | Modified dimethylsilicone oil | 0.1 |
| | (product name: SH28PA, | |
| | manufactured by Dow Corning | |
| | Toray Silicone Co., Ltd.) | |

Then, 210 g of the above-mentioned mixed solution and 200 g of glass beads having an average particle diameter of 0.8 mm as media were mixed in a 450 mL glass bottle, and the mixture was predispersed using a paint shaker dispersing machine for 24 hours.

Further, to the glass bottle containing a coating material that had finished being dispersed, 30 parts by mass of polyurethane particles having an average particle diameter of 7.0 μm (product name: DAIMICBEAZ UCN-5070D: manufactured by Dainichiseika Color & Chemicals Mfg. Co., Ltd.) were added with respect to 100 parts by mass of the caprolactone-modified acrylic polyol, and the mixture was dispersed again with a paint shaker for 15 minutes to provide a coating material for forming a surface layer.

The roller A with an electroconductive layer was dipped in the coating material for forming a surface layer with its longitudinal direction being a vertical direction, and was coated therewith by a dipping method. In the dip coating, a dipping time was 9 seconds, and a lifting speed was 20 mm/sec as an initial speed and 2 mm/sec as a final speed, and the speed was linearly changed with time therebetween. The resultant coated product was air-dried at normal temperature for 30 minutes, then dried in a hot air-circulating dryer set to 90° C. for 1 hour, and further dried in a hot air-circulating dryer set to 160° C. for 1 hour to produce [Charging Member 2] according to the present disclosure.

The universal hardness of [Charging Member 2] of this Example was 25 N/mm².

[Evaluation]

A laser beam printer manufactured by Hewlett-Packard Company (product name: Laser Jet Enterprise M404) was used as an evaluation apparatus. In addition, its process cartridge was reconstructed by changing a spring to be used for a bearing for a charging roller so that the charging roller abutted on an electrophotographic photosensitive member with a pressing pressure of 2.9 N at one end, i.e., 5.9 N at both ends. When the abutting pressure is reduced as just described, a banding image is made more liable to occur, and hence a severer evaluation can be performed.

<Evaluation of Occurrence Status of Banding Image (Evaluation (1))>

An electrophotographic photosensitive member, a toner, and a charging roller were incorporated into the electrophotographic apparatus, and the resultant was left to stand under a high-temperature and high-humidity environment (temperature: 31.5° C., relative humidity: 80%) for 24 hours or more. After that, image evaluation was performed in that environment. Specifically, with a charging potential set to −500 V and an exposure potential set to −150 V, a halftone image (such an image that horizontal lines each having a width of 1 dot were drawn in a direction perpendicular to the rotation direction of the electrophotographic photosensitive member at intervals of 2 dots) was output and evaluated. For the evaluation, the occurrence status of horizontal streak-like unevenness in the halftone image due to charging was visually observed, and was judged by the following criteria.

TABLE 8

| Rank | Evaluation result |
|---|---|
| A | Horizontal streak-like unevenness is not found. |
| B | Horizontal streak-like unevenness is slightly found. |
| C | Horizontal streak-like unevenness is found at a position |
| | corresponding to the rotation pitch of the charging roller. |
| D | Horizontal streak-like unevenness is remarkably visible. |

<Evaluation of Occurrence Status of Banding Image after Endurance (Evaluation (2))>

With use of the same evaluation apparatus and process cartridge as those of the evaluation (1), a 10,000-sheet passing endurance test was performed under a high-temperature and high-humidity environment (temperature: 31.5° C., relative humidity: 80%). After 10,000-sheet passing, the same image evaluation as in the evaluation (1) was performed, and a judgment was made by the above-mentioned criteria.

### Example 1

The electrophotographic photosensitive member 1, the toner 1, and the charging member 1 produced in the foregoing were mounted onto the process cartridge, and the above-mentioned evaluations (1) and (2) were performed. The results are shown in Table 9.

### Examples 2 to 30

Evaluations were performed in the same manner as in Example 1 except that the combination of the electrophotographic photosensitive member, the toner, and the charging member was changed as shown in Table 9. The results of the evaluations are shown in Table 9.

### Comparative Examples 1 to 11

Evaluations were performed in the same manner as in Example 1 except that the combination of the electrophotographic photosensitive member, the toner, and the charging member was changed as shown in Table 10. The results of the evaluations are shown in Table 10. In each of Comparative Examples, a horizontal streak-like failure image was conspicuous.

TABLE 9

| Example | Electrophotographic | | | Evaluation | Evaluation |
|---|---|---|---|---|---|
| No. | Photosensitive member | Toner | Charging member | (1) rank | (2) rank |
| 1 | Electrophotographic | Toner 1 | Charging member 1 | A | A |
| | Photosensitive member 1 | | | | |
| 2 | Electrophotographic | Toner 2 | Charging member 1 | B | B |
| | Photosensitive member 2 | | | | |
| 3 | Electrophotographic | Toner 3 | Charging member 1 | B | B |
| | Photosensitive member 3 | | | | |
| 4 | Electrophotographic | Toner 4 | Charging member 1 | A | B |
| | Photosensitive member 4 | | | | |
| 5 | Electrophotographic | Toner 5 | Charging member 1 | B | B |
| | Photosensitive member 5 | | | | |
| 6 | Electrophotographic | Toner 6 | Charging member 1 | B | B |
| | Photosensitive member 6 | | | | |
| 7 | Electrophotographic | Toner 7 | Charging member 1 | A | A |
| | Photosensitive member 7 | | | | |
| 8 | Electrophotographic | Toner 8 | Charging member 1 | A | A |
| | Photosensitive member 8 | | | | |
| 9 | Electrophotographic | Toner 6 | Charging member 1 | A | B |
| | Photosensitive member 9 | | | | |
| 10 | Electrophotographic | Toner 3 | Charging member 1 | A | B |
| | Photosensitive member 10 | | | | |
| 11 | Electrophotographic | Toner 9 | Charging member 1 | A | B |
| | Photosensitive member 11 | | | | |
| 12 | Electrophotographic | Toner 5 | Charging member 2 | B | B |
| | Photosensitive member 13 | | | | |
| 13 | Electrophotographic | Toner 5 | Charging member 1 | B | C |
| | Photosensitive member 14 | | | | |
| 14 | Electrophotographic | Toner 7 | Charging member 1 | B | C |
| | Photosensitive member 15 | | | | |
| 15 | Electrophotographic | Toner 10 | Charging member 1 | B | C |
| | Photosensitive member 16 | | | | |
| 16 | Electrophotographic | Toner 4 | Charging member 1 | B | C |
| | Photosensitive member 17 | | | | |
| 17 | Electrophotographic | Toner 11 | Charging member 1 | C | C |
| | Photosensitive member 18 | | | | |
| 18 | Electrophotographic | Toner 6 | Charging member 1 | C | C |
| | Photosensitive member 14 | | | | |
| 19 | Electrophotographic | Toner 3 | Charging member 1 | B | C |
| | Photosensitive member 19 | | | | |
| 20 | Electrophotographic | Toner 5 | Charging member 1 | B | C |
| | Photosensitive member 20 | | | | |
| 21 | Electrophotographic | Toner 2 | Charging member 1 | B | C |
| | Photosensitive member 21 | | | | |
| 22 | Electrophotographic | Toner 8 | Charging member 1 | B | C |
| | Photosensitive member 22 | | | | |
| 23 | Electrophotographic | Toner 6 | Charging member 1 | C | C |
| | Photosensitive member 23 | | | | |
| 24 | Electrophotographic | Toner 3 | Charging member 1 | C | C |
| | Photosensitive member 20 | | | | |
| 25 | Electrophotographic | Toner 11 | Charging member 1 | B | C |
| | Photosensitive member 24 | | | | |
| 26 | Electrophotographic | Toner 6 | Charging member 1 | B | C |
| | Photosensitive member 25 | | | | |
| 27 | Electrophotographic | Toner 12 | Charging member 1 | B | C |
| | Photosensitive member 12 | | | | |
| 28 | Electrophotographic | Toner 13 | Charging member 1 | B | C |
| | Photosensitive member 13 | | | | |
| 29 | Electrophotographic | Toner 7 | Charging member 1 | C | C |
| | Photosensitive member 26 | | | | |
| 30 | Electrophotographic | Toner 10 | Charging member 1 | C | C |
| | Photosensitive member 27 | | | | |

TABLE 10

| Comparative | Electrophotographic | | | Evaluation | Evaluation |
|---|---|---|---|---|---|
| Example No. | Photosensitive member | Toner | Charging member | (1) rank | (2) rank |
| 1 | Electrophotographic | Toner 14 | Charging member 1 | C | D |
| | Photosensitive member 20 | | | | |
| 2 | Electrophotographic | Toner 15 | Charging member 1 | C | D |
| | Photosensitive member 12 | | | | |
| 3 | Electrophotographic | Toner 6 | Charging member 1 | C | D |
| | Photosensitive member 28 | | | | |
| 4 | Electrophotographic | Toner 8 | Charging member 1 | C | D |
| | Photosensitive member 29 | | | | |
| 5 | Electrophotographic | Toner 16 | Charging member 1 | C | D |
| | Photosensitive member 27 | | | | |
| 6 | Electrophotographic | Toner 17 | Charging member 1 | C | D |
| | Photosensitive member 29 | | | | |
| 7 | Electrophotographic | Toner 18 | Charging member 1 | C | D |
| | Photosensitive member 30 | | | | |
| 8 | Electrophotographic | Toner 19 | Charging member 1 | D | D |
| | Photosensitive member 15 | | | | |
| 9 | Electrophotographic | Toner 20 | Charging member 1 | D | D |
| | Photosensitive member 15 | | | | |
| 10 | Electrophotographic | Toner 21 | Charging member 1 | D | D |
| | Photosensitive member 15 | | | | |
| 11 | Electrophotographic | Toner 22 | Charging member 1 | D | D |
| | Photosensitive member 31 | | | | |

According to the present disclosure, the process cartridge capable of suppressing the occurrence of a banding image due to stick-slip between an electrophotographic photosensitive member and a contact member, thereby being capable of forming a high-quality electrophotographic image, even at the time of long-term endurance under high temperature and high humidity can be provided.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-039630, filed Mar. 14, 2022, which is hereby incorporated by reference herein in its entirety.

What is claimed is:

1. A process cartridge removably mountable onto a main body of an electrophotographic apparatus, the process cartridge comprising:
an electrophotographic photosensitive member;
a toner; and
a developing member configured to supply the toner to the electrophotographic photosensitive member,
wherein the electrophotographic photosensitive member comprises a surface layer comprising:
a particle A containing a metal atom; and
a binder resin,
wherein the toner includes:
a toner particle; and
a hydrotalcite particle as an external additive,
wherein, in filter fitting analysis in STEM-EDS analysis, the hydrotalcite particle comprises fluorine, and
wherein, when a number-average primary particle diameter of the particle A is represented by “m” [nm], a content ratio of the particle A with respect to the surface layer is represented by “p” [vol %], and a number-average primary particle diameter of the hydrotalcite particle is represented by “h” [nm], the “m”, the “p”, and the “h” satisfy the following expressions (1), (2), and (3), respectively:
5≤m≤300 Expression (1);
5≤p≤40 Expression (2); and
60≤h≤1,000 Expression (3).

2. The process cartridge according to claim 1, wherein the particle A is a metal oxide particle.

3. The process cartridge according to claim 2, wherein the metal oxide particle comprises at least one selected from the group consisting of a titanium oxide particle and a tin oxide particle.

4. The process cartridge according to claim 1, wherein the binder resin is a (meth)acrylic resin.

5. The process cartridge according to claim 1, wherein the “m”, the “p”, and the “h” satisfy a relationship represented by the following expression (4).
2(p^{-1/3}−1)m≤h≤20(p^{-1/3}−1)m Expression (4)

6. The process cartridge according to claim 1, wherein the particle A is subjected to surface treatment.

7. The process cartridge according to claim 6, wherein the surface treatment is silane coupling treatment.

8. The process cartridge according to claim 6,
wherein the surface treatment is treatment with a compound having a polymerizable monomer, and
wherein the polymerizable monomer has a (meth)acryloyloxy group.

9. The process cartridge according to claim 1, wherein, in the filter fitting analysis in the STEM-EDS analysis, the hydrotalcite particle comprises magnesium and aluminum.

10. The process cartridge according to claim 1, wherein, in line analysis in the STEM-EDS analysis, fluorine is present inside of the hydrotalcite particle.

11. The process cartridge according to claim 1, further comprising a charging roller,
wherein the charging roller includes:
an electroconductive support; and
an electroconductive layer arranged on an outer peripheral surface of the electroconductive support, and
wherein the charging roller has a universal hardness of from 1.0 N/mm² to 20.0 N/mm² at a position having a depth of 1 μm from a surface thereof.

12. An electrophotographic apparatus comprising a process cartridge removably mountable onto a main body of the electrophotographic apparatus, the process cartridge comprising:
an electrophotographic photosensitive member;
a toner; and
a developing member configured to supply the toner to the electrophotographic photosensitive member,
wherein the electrophotographic photosensitive member comprises a surface layer comprising:
a particle A containing a metal atom; and
a binder resin,
wherein the toner includes:
a toner particle; and
a hydrotalcite particle as an external additive,
wherein, in filter fitting analysis in STEM-EDS analysis, the hydrotalcite particle comprises fluorine, and
wherein, when a number-average primary particle diameter of the particle A is represented by “m” [nm], a content ratio of the particle A with respect to the surface layer is represented by “p” [vol %], and a number-average primary particle diameter of the hydrotalcite particle is represented by “h” [nm], the “m”, the “p”, and the “h” satisfy the following expressions (1), (2), and (3), respectively:
5≤m≤300 Expression (1);
5≤p≤40 Expression (2); and
60≤h≤1,000 Expression (3).
